(19) United States
(12) Patent Application Publication
(10) Pub. No.: US 2011/0005255 A1
(43) Pub. Date: Jan. 13, 2011

(54) Vehicular air-conditioning system

(75) Inventors: Takuya Tanihata, Nagoya-city (JP); Hirotaka Egami, Kariya-city (JP); Shun Kurata, Kariya-city (JP); Yoshinori Ichishi, Kariya-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/803,285

(22) Filed: Jun. 23, 2010

(30) Foreign Application Priority Data
Jul. 9, 2009 (JP) 2009-162493

(51) Int. Cl. F25B 27/00; B60S 1/54; B60H 1/02; F24F 7/00; B60H 1/32

(52) U.S. Cl. 62/238.7; 454/121; 454/159; 165/59; 62/244

(57) ABSTRACT

A vehicular air-conditioning system provided with a vapor compression type refrigerating machine improved in practicality, provided with a vapor compression type refrigeration cycle 10 having a compressor 11 compressing and discharging a refrigerant and an outside heat exchanger 16 exchanging heat with the air outside of the cabin and the refrigerant and designed to be able to switch between a cooler cycle cooling vented air blown into the cabin and a heat pump cycle heating the vented air, a heating means 36 for using cooling water of an internal combustion engine EG as a heat source for heating the vented air, a vent mode switch 60c setting a defogging mode blowing out vented air toward the vehicle window glass by operation by a passenger, and a control means 50 controlling switching between the cooler cycle and heat pump cycle, the control means 50 selecting the cooler cycle and outputting a signal requesting operation to the internal combustion engine EG when the vent mode switch 60c is used to set the defogging mode.

### TECHNICAL FIELD

The present invention relates to a vehicular air-conditioning system provided with a vapor compression type refrigerating machine forming a heat pump cycle.

### BACKGROUND ART

In the past, in this type of vehicular air-conditioning system, there was the problem that when performing heating by the heat pump cycle at the time of a low outside air temperature, frost would form on an outside heat exchanger resulting in a drop in the heat exchange efficiency of the outside heat exchanger.

Therefore, in the prior art of Patent Literature 1, when frost forms on the outside heat exchanger, the cooler cycle is switched to so as to run high temperature refrigerant through the outside heat exchanger and remove the frost from the outside heat exchanger.

Further, in this prior art, even when frost forms on the outside heat exchanger, when the DEF mode (defroster mode) is selected for blowing warm air on the surface of the vehicle window glass on the cabin side, the heat pump cycle is continued without switching to the cooler cycle.

That is, if switching to the cooler cycle in the DEF mode, cool air is blown out to the vehicle window glass, so at the time of the DEF mode, the heat pump cycle is continued so that warm air is blown out to the window glass.

### CITATION LIST

Patent Literature

Patent Literature 1: Japanese Patent Publication (A) No. 8-268033

### SUMMARY OF THE INVENTION

### Technical Problem

However, in the above prior art, there are various problems in practicality. For example, the heat pump cycle does not have a drying ability, so in the above prior art which selected the heat pump cycle at the time of the DEF mode, non-dried moist air is blown out to the vehicle window glass, so sufficient defogging ability of the window glass cannot be secured.

Further, for example, in the above prior art, at the time of the DEF mode, priority is given to preventing fogging the window glass rather than removing frost from the outside heat exchanger, so a drop in the heat exchange efficiency is invited due to formation of frost and in turn a drop in the temperature of the vented air (warm air) ends up being invited. For this reason, not only is a drop in the defogging ability of the window glass invited, but also the feeling of warmth of the passengers ends up being degraded.

The present invention, in view of the above points, has as its first object the improvement of the practicality of a vehicular air-conditioning system provided with a vapor compression type refrigerating machine forming a heat pump cycle.

Further, the present invention has as its second object the improvement of the defogging ability of window glass and the prevention of formation of frost on an outside heat exchanger.

### Solution to Problem

To achieve the above objects, in the aspect of the invention described in claim 1, there is provided a vehicular air-conditioning system provided with a vapor compression type refrigeration cycle (10) having a compressor (11) compressing and discharging a refrigerant and an outside heat exchanger (16) exchanging heat between air outside a cabin and a refrigerant and able to switch between a cooler cycle cooling vented air to be blown inside the cabin and a heat pump cycle heating the vented air,

a heating means (36) for using cooling water of an internal combustion engine (EG) as a heat source to heat the vented air,

a vent mode switch (60c) setting a defogging mode for blowing vented air toward vehicle window glass by operation by a passenger, and

a control means (50) for controlling switching between the cooler cycle and heat pump cycle, the control means (50) selecting the cooler cycle and outputting a signal requesting operation to the internal combustion engine (EG) even when the vent mode switch (60c) is used to set the defogging mode.

According to this, when the vent mode switch (60c) is used to set the defogging mode, the cooler cycle is selected and a signal requesting operation is output to the internal combustion engine (EG), so the vented air can be dried by the cooler cycle and the vented air can be heated by the heating means (36) using the cooling water of the internal combustion engine (EG) as a heat source. For this reason, the defogging ability of the window glass can be improved.

Further, by selecting the cooler cycle, it is possible to prevent formation of frost at the outside heat exchanger (16). Due to the above, the practicality can be improved.

In the aspect of the invention described in claim 2, there is provided a vehicular air-conditioning system as set forth in claim 1 wherein the control means (50) selects the heat pump cycle instead of the cooler cycle, even when the vent mode switch (60c) is used to set the defogging mode, when the temperature of the cooling water is lower than a predetermined temperature.

According to this, the heat pump cycle is selected when the temperature of the cooling water is lower than a predetermined temperature, so the venting of low temperature air at the time of the defogging mode can be suppressed. For this reason, it is possible to suppress a drop in the feeling of warmth of the passengers at the time of the defogging mode.

In the aspect of the invention described in claim 3, there is provided a vehicular air-conditioning system as set forth in claim 1 or 2 wherein the control means (50) outputs a signal requesting operation to the internal combustion engine (EG) when the vent mode switch (60c) is used to set the defogging mode and it is judged that the possibility of window fogging is high.

According to this, when it is judged that the possibility of window fogging is low, it is possible to prevent a signal requesting operation from being output to the internal combustion engine (EG), so the operating frequency of the internal combustion engine (EG) can be reduced and in turn the fuel economy can be improved and exhaust gas emissions can be reduced.

In the aspect of the invention described in claim 4, there is provided a vehicular air-conditioning system as set forth in any one of claims 1 to 3 wherein the control means (50) selects the cooler cycle when the vent mode switch (60c) is used to set the defogging mode and it is judged that the possibility of window fogging is high.

According to this, when it is judged that the possibility of window fogging is low, it is possible to prevent selection of the cooler cycle, so at the time of the defogging mode, it is possible to suppress the venting of low temperature air. For this reason, at the time of the defogging mode, a drop in the feeling of warmth of the passengers can be suppressed.

In the aspect of the invention described in claim 5, there is provided a vehicular air-conditioning system provided with

a vapor compression type refrigeration cycle (10) having a compressor (11) designed to be able to switch between a non-drying heat pump cycle heating the vented air blown into a cabin without drying it and a drying heat pump cycle drying and heating the vented air,

a vent mode switch (60c) setting a defogging mode for blowing vented air toward vehicle window glass by operation by a passenger, and

a control means (50) for controlling switching between the non-drying heat pump cycle and the drying heat pump cycle,

the control means (50) permitting operation by the drying heat pump cycle when the vent mode switch (60c) is used to set the defogging mode.

In this regard, the cooler cycle has a drying ability, but does not have a heating ability, so if selecting the cooler cycle at the time of the defogging mode, there is the practical problem that other heating means would become necessary for securing the feeling of warmth of the passengers.

As opposed to this, in the aspect of the invention of claim 5, when the vent mode switch (60c) is used to set the defogging mode, operation by the drying heat pump cycle is permitted, so at the time of the defogging mode, both a heating ability and drying ability can be exhibited. For this reason, the feeling of warmth of the passengers can be secured, a defogging ability can be secured, and in turn practicality can be improved.

In the aspect of the invention described in claim 6, there is provided a vehicular air-conditioning system provided with

a vapor compression type refrigeration cycle (10) having a compressor (11) compressing and discharging a refrigerant and an outside heat exchanger (16) exchanging heat between air outside a cabin and a refrigerant and able to switch between a cooler cycle cooling vented air to be blown inside the cabin and a heat pump cycle heating the vented air,

heating means (36, 37) for using a source other than the refrigerant as heat to heat the vented air,

a vent mode switch (60c) setting a defogging mode for blowing vented air toward vehicle window glass by operation by a passenger, and

a control means (50) for controlling switching between the cooler cycle and heat pump cycle,

the control means (50) selecting the cooler cycle and increasing the heating ability of the heating means (36, 37) when the vent mode switch (60c) is used to set the defogging mode.

According to this, when the vent mode switch (60c) is used to set the defogging mode, the cooler cycle is selected and the heating ability of the heating means (36, 37) is increased, so it is possible to dry the vented air in the cooler cycle and suppress the venting of low temperature air at the time of the defogging mode.

Further, by selecting the cooler cycle, it is possible to prevent formation of frost on the outside heat exchanger (16). Due to the above, it is possible to improve the practicality.

Note that, as specific examples of heating means, a heater core (36) using cooling water of the internal combustion engine (EG) as a heat source to heat the vented air, an electric heater (37) being fed power to generate heat, etc. may be mentioned.

In the aspect of the invention described in claim 7, there is provided a vehicular air-conditioning system provided with

a vapor compression type refrigeration cycle (10) having a compressor (11) compressing and discharging a refrigerant and an outside heat exchanger (16) exchanging heat between air outside a cabin and a refrigerant and able to switch between a cooler cycle cooling vented air to be blown inside the cabin and a heat pump cycle heating the vented air,

a window glass heating means (47) for heating the vehicle window glass,

a vent mode switch (60c) setting a defogging mode for blowing vented air toward the vehicle window glass by operation by a passenger, and

a control means (50) for controlling switching between the cooler cycle and heat pump cycle,

the control means (50) selecting the cooler cycle and operating the window glass heating means (47) when the vent mode switch (60c) is used to set the defogging mode.

According to this, when the vent mode switch (60c) is used to set the defogging mode, the cooler cycle is selected and the window glass heating means (47) is operated, so it is possible to dry the vented air at the cooler cycle and possible to heat the vehicle window glass by the window glass heating means (47). For this reason, it is possible to improve the defogging ability of the window glass.

Further, by selecting the cooler cycle, it is possible to prevent the formation of frost at the outside heat exchanger (16). Due to the above, the practicality can be improved.

In the aspect of the invention described in claim 8, there is provided a vehicular air-conditioning system provided with

a vapor compression type refrigeration cycle (10) having a compressor (11) compressing and discharging a refrigerant and an outside heat exchanger (16) exchanging heat between air outside a cabin and a refrigerant and able to switch between a cooler cycle cooling vented air to be blown inside the cabin and a heat pump cycle heating the vented air,

a seat heating device (48) arranged at a seat,

a vent mode switch (60c) setting a defogging mode for blowing vented air toward the vehicle window glass by operation by a passenger, and

a control means (50) for controlling switching between the cooler cycle and heat pump cycle,

the control means (50) selecting the cooler cycle and operating the seat heating device (48) when the vent mode switch (60c) is used to set the defogging mode.

According to this, when the vent mode switch (60c) is used to set the defogging mode, the cooler cycle is selected and the seat heating device (48) is operated, so it is possible to dry the vented air at the cooler cycle and possible to effectively warm a passenger by the seat heating device (48). For this reason, it is possible to improve the defogging ability of the window glass and to secure the feeling of warmth of the passengers.

Further, by selecting the cooler cycle, it is possible to prevent the formation of frost at the outside heat exchanger (16). Due to the above, the practicality can be improved.

Note that the numerals in parentheses after the above means described in this section and in the claims show the correspondence with specific means described in the later explained embodiments.

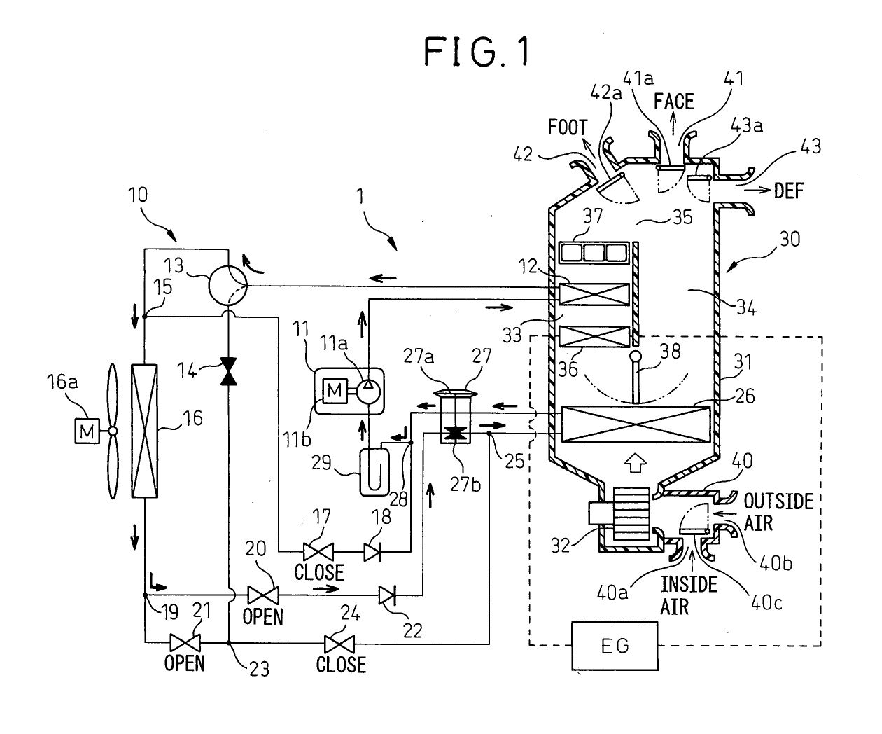

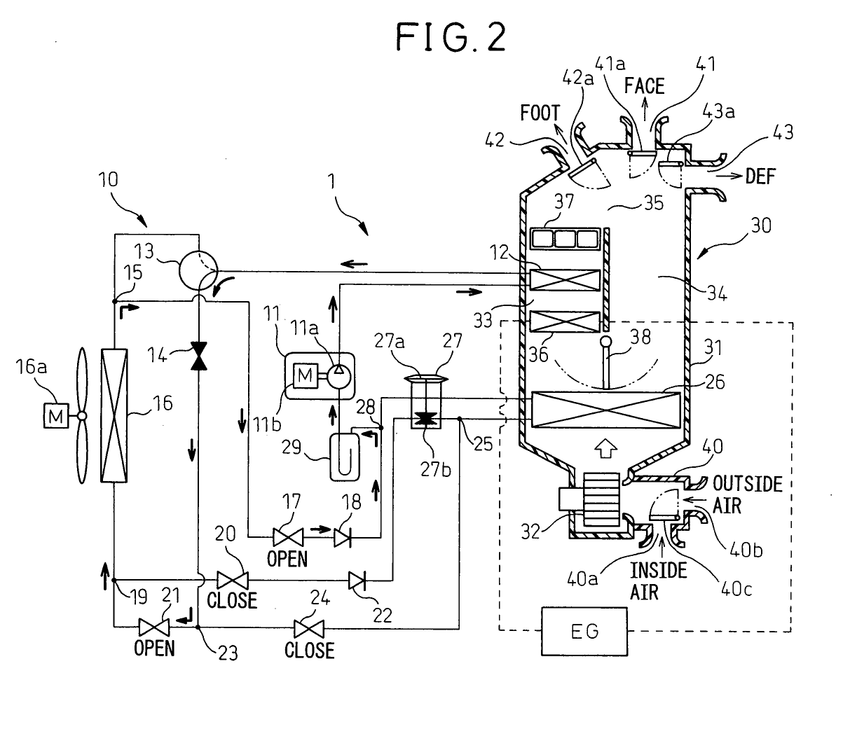

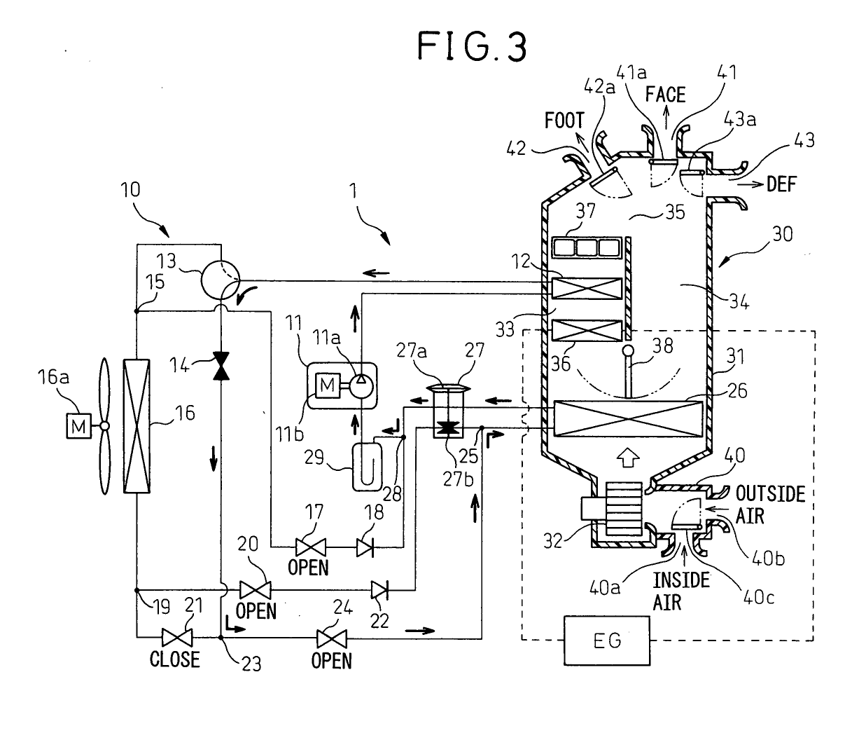

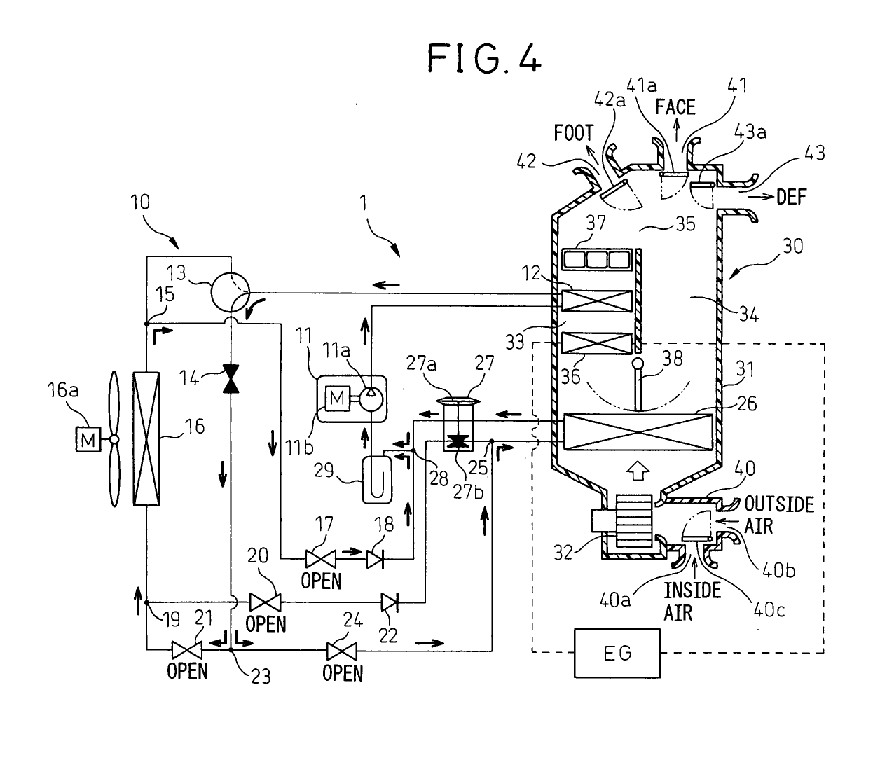

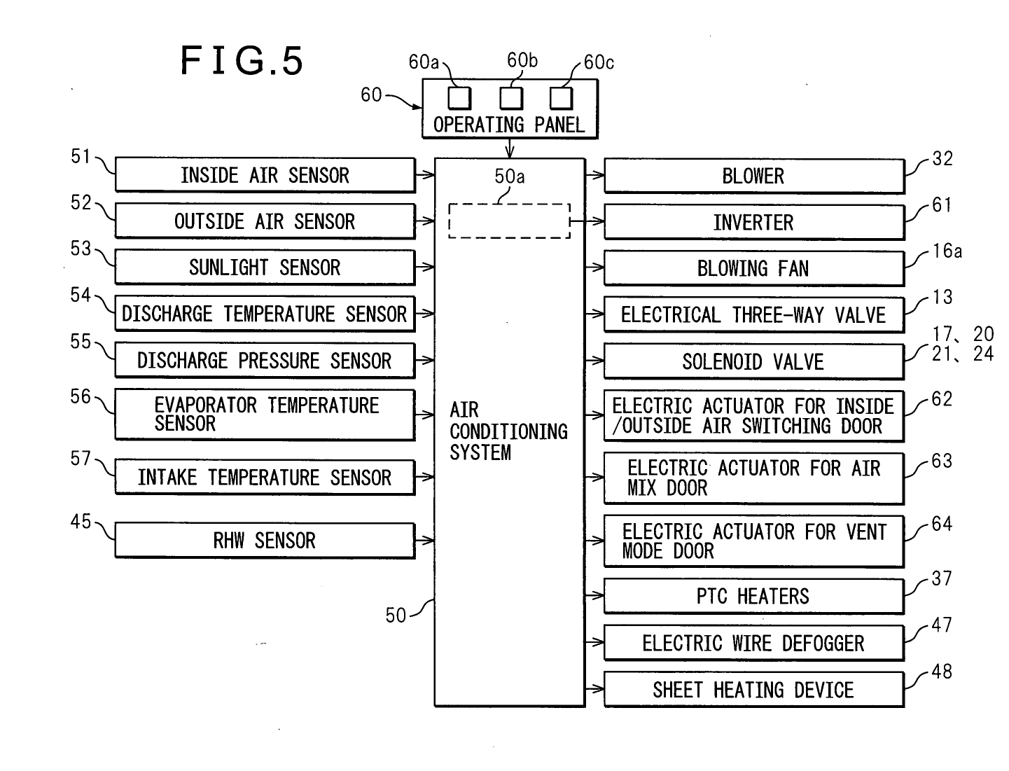

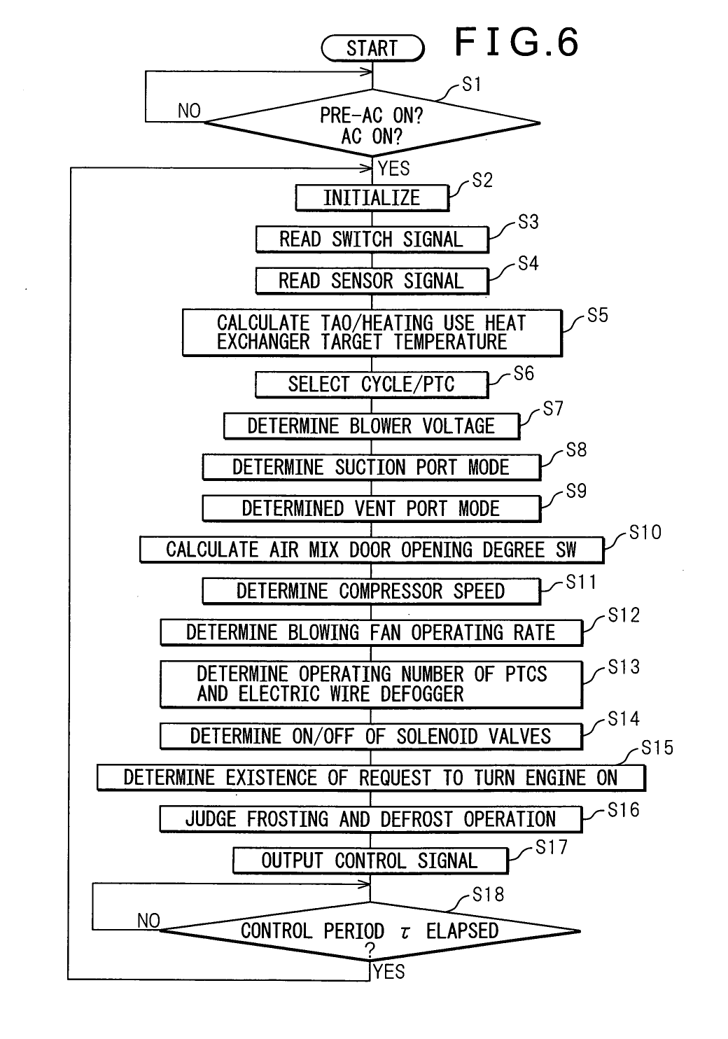

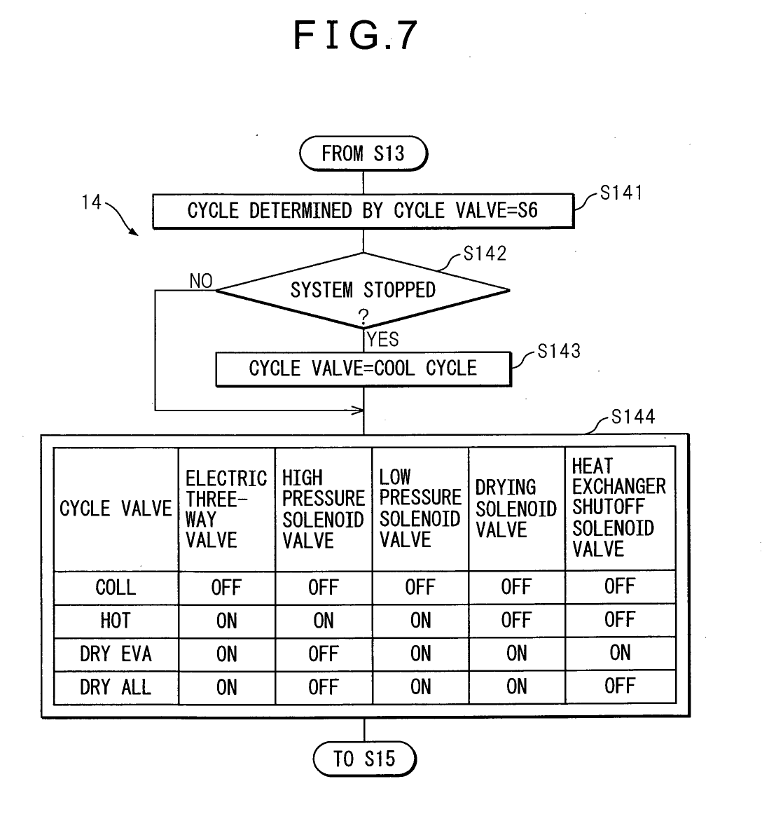

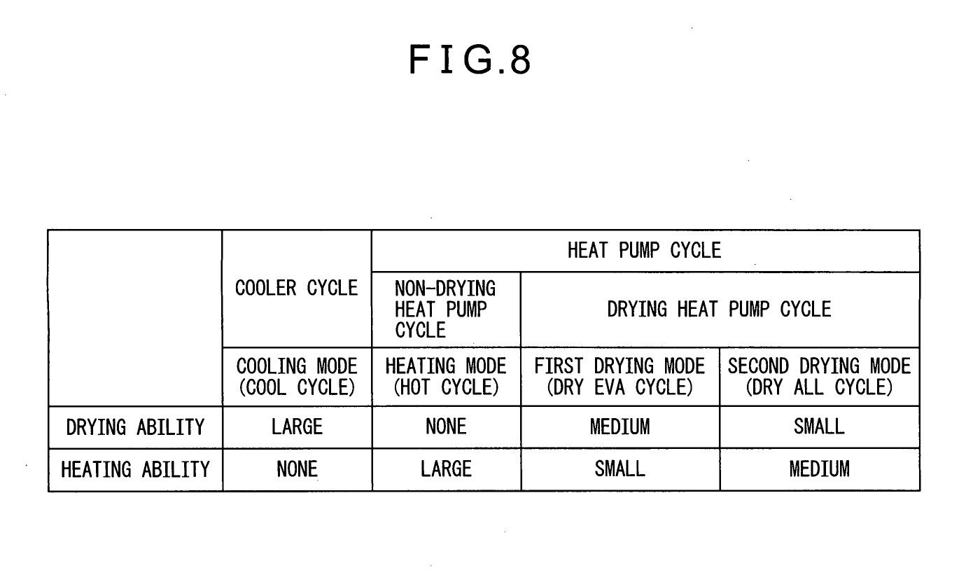

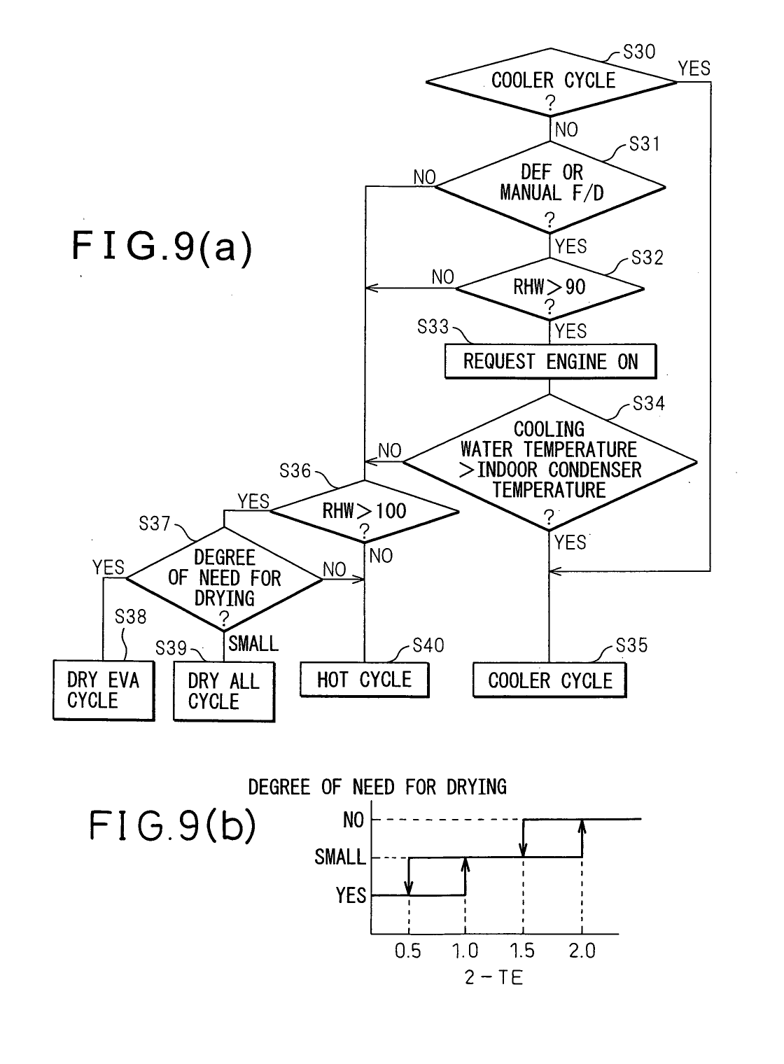

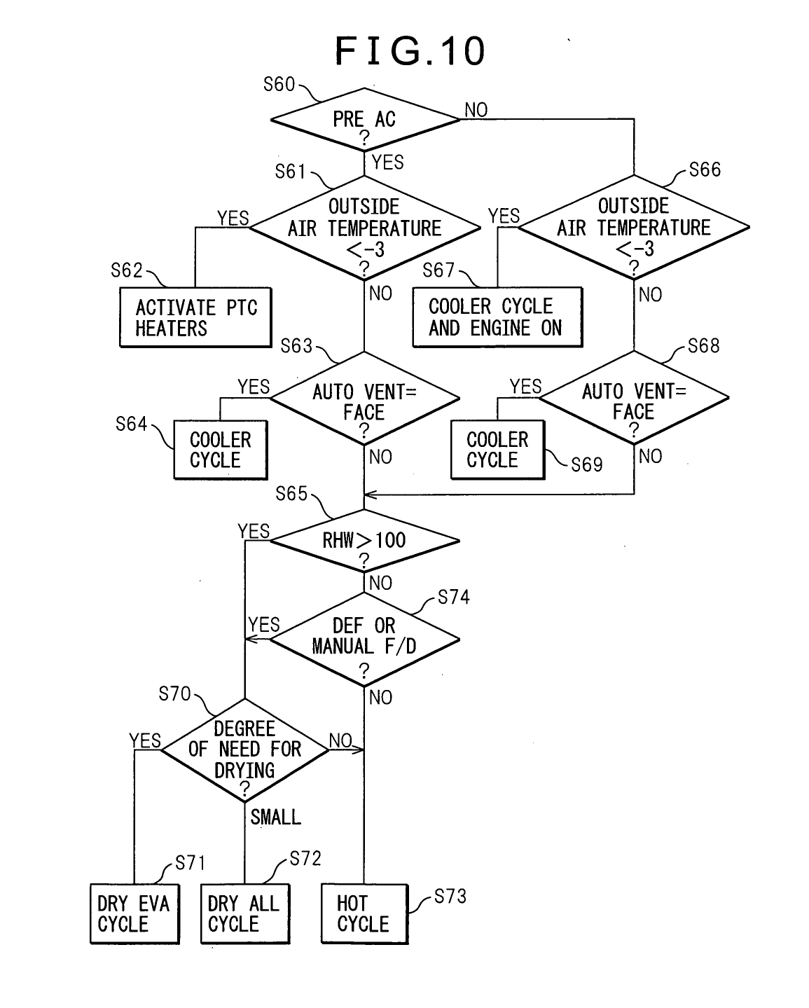

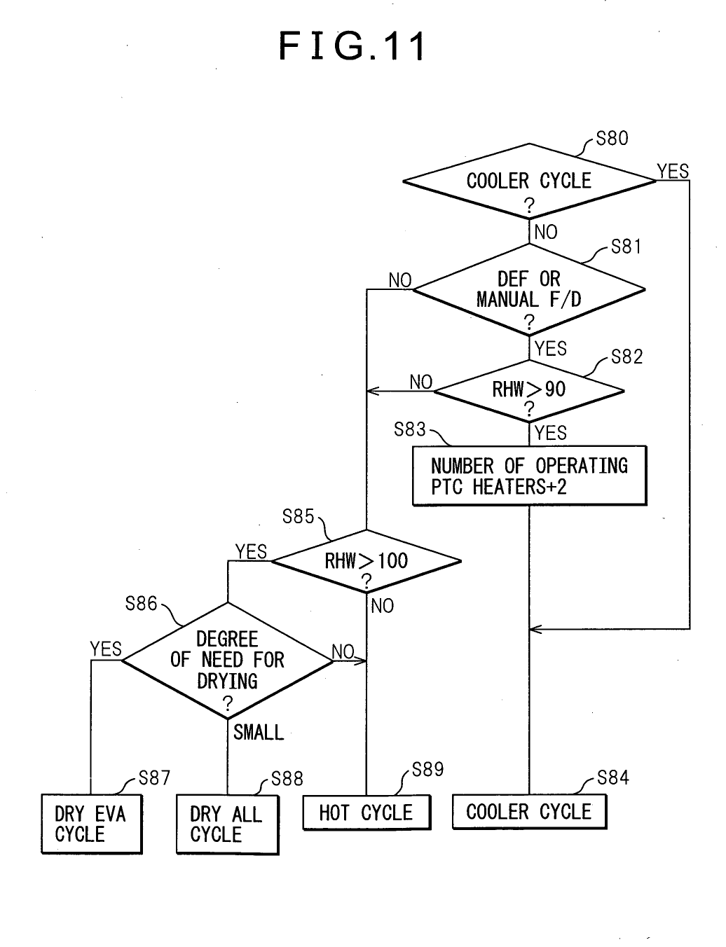

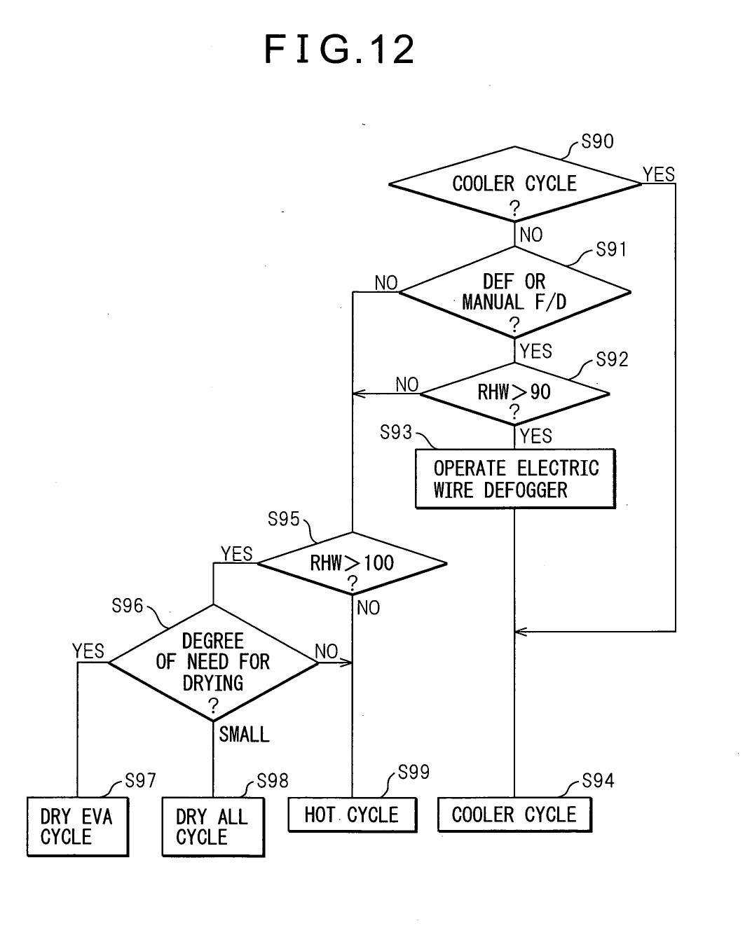

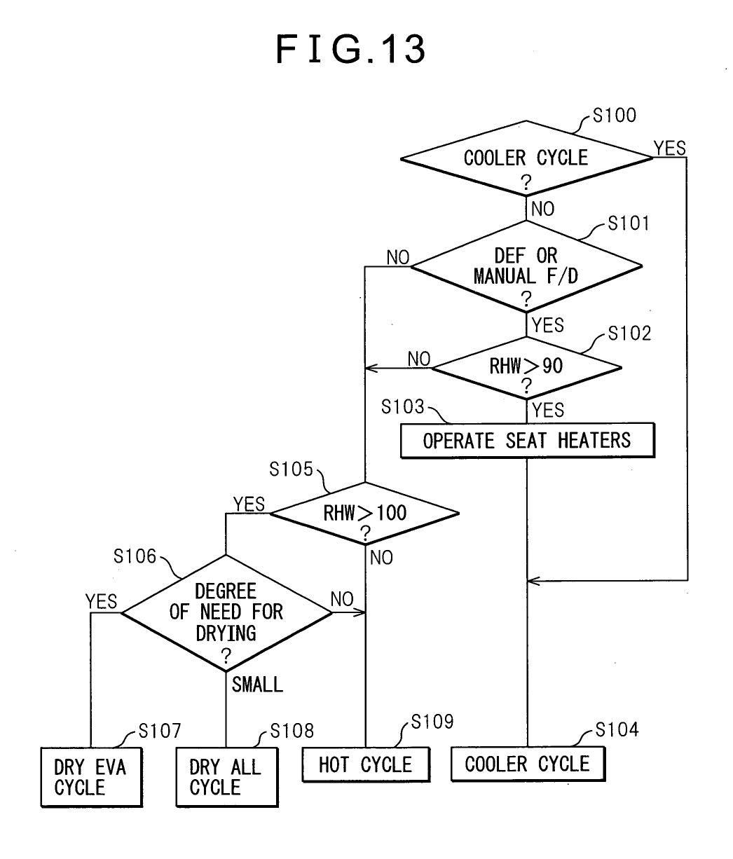

### BRIEF DESCRIPTION OF THE DRAWINGS

[FIG. 1] is a view of the configuration of a vehicular air-conditioning system in a first embodiment of the present invention and shows the time of a cooling mode.

[FIG. 2] is a view of the configuration of a vehicular air-conditioning system in a first embodiment of the present invention and shows the time of a heating mode.

[FIG. 3] is a view of the configuration of a vehicular air-conditioning system in a first embodiment of the present invention and shows the time of a first drying mode.

[FIG. 4] is a view of the configuration of a vehicular air-conditioning system in a first embodiment of the present invention and shows the time of a second drying mode.

[FIG. 5] is a view of the configuration of an electrical control unit of the vehicular air-conditioning system of the first embodiment.

[FIG. 6] is a flowchart showing a control routine of the vehicular air-conditioning system of the first embodiment.

[FIG. 7] is a flowchart showing details of step S14 of FIG. 6.

[FIG. 8] is a table showing a drying ability and heating ability in different operating modes of the vehicular air-conditioning system of the first embodiment.

[FIG. 9] is a flowchart showing the main parts of the control processing of a first embodiment.

[FIG. 10] is a flowchart showing the main parts of the control processing of a second embodiment.

[FIG. 11] is a flowchart showing the main parts of the control processing Of a third embodiment.

[FIG. 12] is a flowchart showing the main parts of the control processing of a fourth embodiment.

[FIG. 13] is a flowchart showing the main parts of the control processing of a fifth embodiment.

### BEST MODE FOR CARRYING OUT THE INVENTION

### First Embodiment

FIG. 1 to FIG. 9 will be used to explain a first embodiment of the present invention. In the present embodiment, the vehicular air-conditioning system of the present invention is applied to a so-called hybrid vehicle obtaining drive power for vehicle operation from an internal combustion engine (engine) EG and a drive use electric motor. FIG. 1 to FIG. 4 are overall views of the configuration of the vehicular air-conditioning system 1.

This vehicular air-conditioning system is provided with a vapor compression type refrigeration cycle 10 configured to be able to switch among refrigerant circuits of a cooling mode cooling an inside of a cabin (COOL cycle), a heating mode heating the inside of the cabin (HOT cycle), a first drying mode drying the inside of the cabin (DRY EVA cycle), and a second drying mode (DRY ALL cycle). FIG. 1 to FIG. 4 show the flows of refrigerant at the time of the cooling mode, heating mode, and first and second drying modes by solid line arrows.

Note that, the cooling mode is the mode operating using the refrigeration cycle 10 as a cooler cycle and has a cooling ability and drying ability. Therefore, the cooling mode can also be expressed as a “cooling and drying mode”.

Further, the heating mode and the first and second drying modes are modes operating the refrigeration cycle 10 as a heat pump cycle. The heating mode among the three modes of this heat pump cycle has a high heating ability, but does not have a drying ability. Therefore, the heating mode may also be expressed as a “non-drying heat pump cycle”.

The first and second drying modes among the three modes of this heat pump cycle have drying abilities, but have heating abilities inferior to the heating mode. Therefore, the first and second drying modes can also be expressed as a drying heat pump cycle.

More specifically, the first drying mode is a drying mode giving priority to the drying ability over the heating ability, while the second drying mode is a drying mode giving priority to the heating ability over the drying ability. Therefore, the first drying mode may also be expressed as a “low temperature drying mode” or simply “drying mode”, while the second drying mode may also be expressed as a “high temperature drying mode” or “drying heating mode”.

Incidentally, the table of FIG. 8 compares the drying abilities and heating abilities of the cooling mode, heating mode, and first and second drying modes. That is, the cooling mode has the largest drying ability, but has no heating ability. Therefore, at the time of heating, when selecting the cooling mode, a heating means other than the refrigeration cycle 10 (in this example, a heater core 36 or PTC heaters 37) is couplingly used.

The heating mode has no drying ability, but has the largest heating ability. The first drying mode has an intermediate extent of drying ability, but a small heating ability. The second drying mode has a small drying ability, but an intermediate extent of heating ability.

The refrigeration cycle 10 is provided with a compressor 11, an inside heat exchanger constituted by an inside condenser 12 and inside evaporator 26, a pressure reducing means for reducing the pressure of and expanding the refrigerant constituted by a temperature type expansion valve 27 and fixed venturi 14, and a refrigerant circuit switching means constituted by a plurality of (in this embodiment, five) solenoid valves 13, 17, 20, 21, 24, etc.

Further, this refrigeration cycle 10 employs as a refrigerant an ordinary CFC based refrigerant and forms a subcritical refrigeration cycle where the high pressure side refrigerant pressure does not exceed the critical pressure of the refrigerant. Furthermore, this refrigerant has refrigerating machine oil for lubricating the compressor 11 mixed into it. This refrigerating machine oil circulates through the cycle along with the refrigerant.

The compressor 11 is arranged in the engine compartment and sucks in, compresses, and discharges refrigerant in the refrigeration cycle 10, so is constituted as an electric compressor driving a fixed capacity type compression mechanism 11a with a fixed discharge capacity by an electric motor 11b. As the fixed capacity type compression mechanism 11a, specifically a scroll type compression mechanism, vane type compression mechanism, or various other types of compression mechanisms may be employed.

The electric motor 11b is an AC motor controlled in operation (speed) by an AC voltage output from an inverter 61. Further, the inverter 61 outputs an AC voltage of a frequency in accordance with a control signal output from a later mentioned air-conditioning control device 50. Further, due to this speed control, the refrigerant discharge ability of the compressor 11 is changed. Therefore, the electric motor 11b comprises a discharge capacity changing means of the compressor 11.

The discharge side of the compressor 11 has the refrigerant inlet side of the inside condenser 12 connected to it. The inside condenser 12 is a heating use heat exchanger arranged in a casing 31 forming an air passage for vented air blown into the cabin in an inside air-conditioning unit 30 of the vehicular air-conditioning system and heating vented air by heat exchange between a refrigerant flowing inside of it and vented air after passing through a later explained inside evaporator 26. Note that, details of the inside air-conditioning unit 30 will be explained later.

The refrigerant outlet side of the inside condenser 12 has an electrical three-way valve 13 connected to it. This electrical three-way valve 13 is a refrigerant circuit switching means controlled in its operation by control voltage output from the air-conditioning control device 50.

More specifically, the electrical three-way valve 13 switches to the refrigerant circuit connecting the refrigerant outlet side of the inside condenser 12 and the refrigerant inlet side of the fixed venturi 14 in the activated state where it is fed power, while switches to the refrigerant circuit connecting the refrigerant outlet side of the inside condenser 12 and one refrigerant flow inlet/outlet of the first three-way coupling 15 in the deactivated state where the feed of power is stopped.

The fixed venturi 14 is a pressure reducing means for heating and drying use which reduces the pressure and expands the refrigerant flowing out from the electrical three-way valve 13 at the time of the heating mode and the first and second drying modes. As this fixed venturi 14, a capillary tube, orifice, etc. can be employed. Of course, as the pressure reducing means for heating and drying use, it is also possible to employ an electrical type variable venturi mechanism where a control signal output from the air-conditioning control device 50 is used to adjust the venturi passage area. The refrigerant outlet side of the fixed venturi 14 has a refrigerant flow inlet/outlet of the later mentioned third three-way coupling 23 connected to it.

The first three-way coupling 15 has three refrigerant flow inlet/outlets and functions as a branch part for branching the refrigerant flow path. Such a three-way coupling may be formed by joining refrigerant pipes or may be formed by providing a metal block or plastic block with a plurality of refrigerant passages. Further, another refrigerant flow inlet/outlet of the first three-way coupling 15 has one refrigerant flow inlet/outlet of the outside heat exchanger 16 connected to it. Still another refrigerant flow inlet/outlet has the refrigerant inlet side of the low pressure solenoid valve 17 connected to it.

The low pressure solenoid valve 17 is a refrigerant circuit switching means having a valve element opening and closing a refrigerant flow path and a solenoid (coil) driving the valve element and controlled in operation by a control voltage output from the air-conditioning control device 50. More specifically, the low pressure solenoid valve 17 is configured as a so-called “normally closed type” of on-off valve which opens when activated and closes when deactivated.

At the refrigerant outlet side of the low pressure solenoid valve 17, one refrigerant flow inlet/outlet of the later explained fifth three-way coupling 28 is connected through a first check valve 18. This first check valve 18 allows only the flow of refrigerant from the low pressure solenoid valve 17 side to the fifth three-way coupling 28 side.

The outside heat exchanger 16 is arranged inside the engine compartment and exchanges heat between refrigerant flowing inside of it and air from outside the cabin blown from a blowing fan 16a (outside air). The blowing fan 16a is an electric blower controlled in speed (vented air rate) by control voltage output from the air-conditioning control device 50.

Furthermore, the blowing fan 16a of the present embodiment blows outside air not only to the outside heat exchanger 16, but also the radiator (not shown) radiating off heat from the cooling water of the engine EG. Specifically, air outside the cabin blown from the blowing fan 16a flows in order from the outside heat exchanger 16→radiator.

Further, the cooling water circuit shown by the broken lines in FIG. 1 to FIG. 4 is provided with a not shown cooling water pump for circulating cooling water. This cooling water pump is an electric type water pump controlled in speed (cooling water circulation rate) by control voltage output from the air-conditioning control device 50.

Another refrigerant flow inlet/outlet of the outside heat exchanger 16 has one refrigerant flow inlet/outlet of the second three-way coupling 19 connected to it. The basic configuration of this second three-way coupling 19 is similar to that of the first three-way coupling 15. Further, another refrigerant flow inlet/outlet of the second three-way coupling 19 has the refrigerant inlet side of the high pressure solenoid valve 20 connected to it, while still another refrigerant flow inlet/outlet has one refrigerant flow inlet/outlet of the heat exchanger cutoff solenoid valve 21 connected to it.

The high pressure solenoid valve 20 and the heat exchanger cutoff solenoid valve 21 are refrigerant circuit switching means controlled in operation by control voltage output from the air-conditioning control device 50. Their basic configurations are similar to that of the low pressure solenoid valve 17. However, the high pressure solenoid valve 20 and the heat exchanger cutoff solenoid valve 21 are constituted as so-called “normal open types” of on-off valves which close when activated and open when deactivated.

The refrigerant outlet side of the high pressure solenoid valve 20 has a venturi mechanism inlet side of the later mentioned temperature type expansion valve 27 connected to it through a second check valve 22. This second check valve 22 allows only the flow of the refrigerant from the high pressure solenoid valve 20 side to the temperature type expansion valve 27 side.

The other refrigerant flow inlet/outlet of the heat exchanger cutoff solenoid valve 21 has one refrigerant flow inlet/outlet of the third three-way coupling 23 connected to it. The basic configuration of this third three-way coupling 23 is similar to that of the first three-way coupling 15. Further, another refrigerant flow inlet/outlet of the third three-way coupling 23, as explained earlier, has the refrigerant outlet side of the fixed venturi 14 connected to it. Still another refrigerant flow inlet/outlet has the refrigerant inlet side of the drying solenoid valve 24 connected to it.

The drying solenoid valve 24 is a refrigerant circuit switching means controlled in operation by control voltage output from the air-conditioning control device 50. Its basic configuration is similar to that of the low pressure solenoid valve 17. Furthermore, the drying solenoid valve 24 is also configured as a “normally closed type” of on-off valve. Further, the refrigerant circuit switching means of the present embodiment is configured by the electrical three-way valve 13, low pressure solenoid valve 17, high pressure solenoid valve 20, heat exchanger cutoff solenoid valve 21, and drying solenoid valve 24, that is, a plurality of (five) solenoid valves.

The refrigerant outlet side of the drying solenoid valve 24 has one refrigerant flow inlet/outlet of the fourth three-way coupling 25 connected to it. The basic configuration of this fourth three-way coupling 25 is similar to that of the first three-way coupling 15. Further, another refrigerant flow inlet/outlet of the fourth three-way coupling 25 has the venturi mechanism outlet side of the temperature type expansion valve 27 connected to it, while still another refrigerant flow inlet/outlet has the refrigerant inlet side of the inside evaporator 26 connected to it.

The inside evaporator 26 is a cooling use heat exchanger arranged inside the casing 31 of the inside air-conditioning unit 30 at the upstream side of the inside condenser 12 along the flow of vented air and exchanges heat between the refrigerant flowing inside of it and the vented air so as to cool the vented air.

The refrigerant outlet side of the inside evaporator 26 has a feeler bulb inlet side of the temperature type expansion valve 27 connected to it. The temperature type expansion valve 27 is a pressure reducing means for cooling use which reduces the pressure of and expands the refrigerant flowing inside from the venturi mechanism inlet and discharging it from the venturi mechanism outlet to the outside.

More specifically, in the present embodiment, as the temperature type expansion valve 27, an internal equal pressure type expansion valve holding in a single housing a feeler bulb 27a detecting a degree of overheating of refrigerant at an outlet side of the inside evaporator 26 based on the temperature and pressure of the refrigerant at the outlet side of the inside evaporator 26 and a variable venturi mechanism 27b adjusting the venturi passage area (refrigerant flow rate) in accordance with displacement of the feeler bulb 27a so that the degree of overheating of refrigerant at an outlet side of the inside evaporator 26 becomes within a preset predetermined range is employed.

The feeler bulb outlet side of the temperature type expansion valve 27 has one refrigerant flow inlet/outlet of the fifth three-way coupling 28 connected to it. The basic configuration of this fifth three-way coupling 28 is similar to that of the first three-way coupling 15. Further, another refrigerant flow inlet/outlet of the fifth three-way coupling 2, as mentioned above, has the refrigerant outlet side of the first check valve 18 connected to it, while still another refrigerant flow inlet/outlet has the refrigerant inlet side of the accumulator 29 connected to it.

The accumulator 29 is a low pressure side gas/liquid separator that separates the refrigerant flowing from the fifth three-way coupling 28 to inside it into gas and, liquid and stores the excess refrigerant. Furthermore, the gaseous phase refrigerant outlet of the accumulator 29 has the refrigerant suction port of the compressor 11 connected to it.

Next, the inside air-conditioning unit 30 will be explained. The inside air-conditioning unit 30 is arranged at the inside of the instrument panel at the frontmost part of the cabin and comprises an outer shell formed by a casing 31 inside of which a blower 32, the above-mentioned inside evaporator 26, inside condenser 12, heater core 36, PTC heaters 37, etc. are housed.

The casing 31 forms an air passage for vented air blown into the cabin and is molded from a resin having a certain degree of elasticity and superior strength-wise as well (for example, polypropylene). At the upstream most side in the casing 31 along the flow of vented air, an inside/outside air switching box 40 switching between introduction of inside air (air inside cabin) and outside air (air outside cabin) is arranged.

More specifically, the inside/outside air switching box 40 is formed with an inside air introduction port 40a for introducing inside air inside the casing 31 and an outside air introduction port 40b for introducing outside air. Furthermore, inside of the inside/outside air switching box 40, an inside/outside air switching door 40c is arranged for continuously adjusting the opening area of the inside air introduction port 40a and outside air introduction port 40b to change the ratio of the flow rate of the inside air and the flow rate of the outside air.

Therefore, the inside/outside air switching door 40c constitutes a flow rate ratio changing means for switching suction port modes for changing the flow rate ratio of the flow rate of inside air and the flow rate of outside air introduced into the casing 31. More specifically, the inside/outside air switching door 40c is driven by an electric actuator 62 for the inside/outside air switching door 40c, while this electric actuator 62 is controlled in operation by a control signal output from the air-conditioning control device 50.

Further, as the suction port modes, there are an inside air mode opening wide the inside air introduction port 40a and fully closing the outside air introduction port 40b to introduce inside air into the casing 31, an outside air mode fully closing the inside air introduction port 40a and opening wide the outside air introduction port 40b to introduce outside air into the casing 31, and an inside/outside air mixing mode continuously adjusting the opening areas of the inside air introduction port 40a and outside air introduction port 40b between the inside air mode and outside air mode so as to continuously change the ratio of introduction of inside air and outside air.

At the downstream side of the inside/outside air switching box 40 along the air flow, a blower 32 is arranged blowing air sucked in through the inside/outside air switching box 40 toward the inside of the cabin. This blower 32 is an electric blower driving a centrifugal multiblade fan (sirocco fan) by an electric motor which is controlled in speed (blowing rate) by control voltage output from the air-conditioning control device 50.

At the downstream side of the blower 32 along the flow of air, the above-mentioned inside evaporator 26 is arranged. Furthermore, at the downstream side of the inside evaporator 26 along the flow of air, air passages such as a heating use cool air passage 33 for the flow of air after passing through the inside evaporator 26 and a cool air bypass passage 34 and a mixing space 35 for mixing air flowing out from the heating use cool air passage 33 and cool air bypass passage 34 are formed.

The heating use cool air passage 33 has arranged in it as heating means for heating the air after passing through the inside evaporator 26 a heater core 36, inside condenser 12, and PTC heaters 37 in that order toward the direction of flow of the vented air. The heater core 36 and PTC heaters 37 are heating means using sources other than the refrigerant for heat so as to heat the vented air.

The heater core 36 is a heating use heat exchanger exchanging heat between cooling water of the engine EG outputting drive power for driving the vehicle and air after passing through the inside evaporator 26 so as to heat the air after passing through the inside evaporator 26.

Further, each PTC heater 37 is an electric heater having a PTC device (positive characteristic thermistor), supplied with power to generate heat, and heating air after passing through the inside condenser 12. Note that, in the present embodiment, a plurality of the PTC heaters 37 (specifically three) are provided. The air-conditioning control device 50 changes the number of activated PTC heaters 37 so as to control the heating ability of the plurality of PTC heaters 37 as a whole.

On the other hand, the cool air bypass passage 34 is an air passage for guiding air after passing through the inside evaporator 26 into the mixing space 35 without passing through the heater core 36, inside condenser 12, and PTC heaters 37. Therefore, the temperature of the vented air mixed in the mixing space 35 changes by the ratio of flow rates of air passing through the heating use cool air passage 33 and the air passing through the cool air bypass passage 34.

Therefore, in the present embodiment, at the downstream side of the inside evaporator 26 along the air flow and the inlet side of the heating use cool air passage 33 and cool air bypass passage 34, an air mix door 38 is arranged for continuously changing the ratio of flow rates of the cool air flowing into the heating use cool air passage 33 and the cool air bypass passage 34.

Therefore, the air mix door 38 constitutes a temperature adjusting means for adjusting the air temperature inside the mixing space 35 (temperature of vented air blown into the cabin). More specifically, the air mix door 38 is driven by an electric actuator 63 for the air mix door. This electric actuator 63 is controlled in operation by a control signal output from the air-conditioning control device 50.

Furthermore, at the downstream most part of the flow of vented air in the casing 31, vents 41 to 43 for blowing air adjusted in temperature from the mixing space 35 to the cooled space, that is, the cabin, are arranged. As the vents 41 to 43, specifically face vents 41 for blowing air-conditioned air toward the upper torsos of the passengers in the cabin, foot vents 42 for blowing air-conditioned air toward the feet of the passengers, and defroster vents 43 for blowing air-conditioned air toward the inside surface of the vehicle front window glass are provided.

Further, at the upstream sides in the air flows of the face vents 41, foot vents 42, and defroster vents 43, face doors 41a for adjusting the opening areas of the face vents 41, foot doors 42a for adjusting the opening areas of the foot vents 42, and defroster doors 43a for adjusting the opening areas of the defroster vents 43 are arranged.

These face doors 41a, foot doors 42a, and defroster doors 43a configure the vent mode switching means for switching the vent mode and are operated to turn interlocked through a not shown link mechanism by being coupled with an electric actuator 64 for vent mode door drive use. Note that, this electric actuator 64 is also controlled in operation by a control signal output from the air-conditioning control device 50.

Further, as vent modes, there are a face mode opening wide the face vents 41 and blowing air from the face vents 41 toward the upper torsos of the passengers in the cabin, a bilevel mode opening both the face vents 41 and the foot vents 42 and blowing air toward the upper torsos and feed of the passengers in the cabin, a foot mode opening wide the foot vents 42 and opening the defroster vents 43 by just a small angle to blow air mainly from the foot vents 42, and a foot and defroster mode opening the foot vents 42 and defroster vents 43 by the same degree and blowing air from both the foot vents 42 and defroster vents 43.

Furthermore, a passenger can manually operate a vent mode switch 60c of an operating panel 60 explained later so as to set a defroster mode opening wide the defroster vents 43 and blowing air from the defroster vents 43 to the inside surface of the vehicle front window glass.

In short, when the foot mode is selected as the vent mode, air is blown out from at least the foot vents 42, while when the foot and defroster mode and defroster mode are selected, the ratio of the flow rate of the air blown out from the defroster vents 43 is greater than that of the foot mode so as to prevent window fogging. Accordingly, the foot and defroster mode and the defroster mode may also be expressed as the “defogging modes”.

Note that, the hybrid vehicle to which the vehicular air-conditioning system 1 of the present embodiment is applied is provided with, separate from the vehicular air-conditioning system, an electric heating defogger 47 and seat heating devices 48. The “electric heating defogger 47” is a window glass heating means comprised of electric heating wires arranged inside or at the surface of the window glass in the cabin and heats the window glass for prevention of fogging or clearing up window fogging.

The seat heating devices 48 are heating devices arranged inside or at the surfaces of seats and directly warming the bodies of passengers to effectively raise the feeling of warmth of the passengers. In the present embodiment, as the seat heating devices 48, electric heating wires generating heat by current are used.

This electric heating defogger 47 and seat heating devices 48 may also be controlled in operation by control signals output from the air-conditioning control device 50.

Next, using FIG. 5, the electrical control part of the present embodiment will be explained. The air-conditioning control device 50 is comprised of a known microcomputer including a CPU, ROM, RAM, etc. and its peripheral circuits. It performs various types of computations and processing based on an air-conditioning control program stored in the ROM and controls the operations of the inverter 61 for the electric motor 11b of the compressor 11 connected to the output side, the refrigerant circuit switching means configured by the solenoid valves 13, 17, 20, 21, and 24, the blowing fan 16a, the blower 32, various types of electric actuators 62, 63, 64, etc.

Note that, the air-conditioning control device 50 is comprised of control means for controlling the above-mentioned various types of devices all combined together. For example, the air-conditioning control device 50 constitutes the control means for controlling the switching among the above-mentioned cooling mode, heating mode, and first and second drying modes.

In the present embodiment, in particular, the constitution (hardware and software) for controlling the operation of the discharge capacity changing means of the compressor 11, that is, the electric motor 11b (refrigerant discharge ability) is made the discharge ability control means 50a. Of course, the discharge ability control means 50a may also be configured separately from the air-conditioning control device 50.

Further, at the input side of the air-conditioning control device 50, detection signals are input from an inside air sensor 51 detecting the cabin temperature Tr, an outside air sensor 52 detecting the outside air temperature Tam (outside air temperature detecting means), a sunlight sensor 53 detecting an amount of sunlight Ts in the cabin, a discharge temperature sensor 54 detecting a discharge refrigerant temperature Td of the compressor 11 (discharge temperature detecting means), a discharge pressure sensor 55 detecting a discharge refrigerant pressure Pd of the compressor 11 (discharge pressure detecting means), an evaporator temperature sensor 56 detecting a temperature TE of air blown from the inside evaporator 26 (evaporator temperature) (evaporator temperature detecting means), a suction temperature sensor 57 detecting a temperature Tsi of a refrigerant flowing between the first three-way coupling 15 and low pressure solenoid valve 17, a cooling water temperature sensor detecting an engine cooling water temperature Tw, a RHW sensor 45 detecting detection values required for calculating the relative humidity RHW of the window glass surface (window glass surface relative humidity detecting means), and other sensors. Here, the window glass surface relative humidity RHW is the relative humidity of the window glass inside side surface.

Note that, the evaporator temperature sensor 56 of the present embodiment specifically detects the heat exchange fin temperature of the inside evaporator 26. Of course, as the evaporator temperature sensor 56, it is also possible to employ a temperature detecting means detecting the temperature of other parts of the inside evaporator 26 or possible to employ a temperature detecting means for directly detecting the temperature of the refrigerant itself flowing through the inside evaporator 26.

Further, the RHW sensor 45 of the present embodiment is specifically comprised of the three sensors of a humidity sensor detecting the relative humidity of cabin air near the window glass in the cabin, a window glass vicinity temperature sensor detecting the temperature of cabin air near the window glass, and a window glass surface temperature sensor detecting the window glass surface temperature.

In the present embodiment, the RHW sensor 45 is arranged at the surface of the vehicle window glass at the inside of the cabin (for example right next to the back mirror at the center top of the vehicle front window glass).

Furthermore, at the input side of the air-conditioning control device 50, operating signals from the various types of air-conditioning operating switches provided at the operating panel 60 arranged near the instrument panel at the front of the cabin are input. As the various types of air-conditioning operating switches provided at the operating panel 60, specifically an operating switch of the vehicular air-conditioning system 1 (not shown), an air-conditioner switch 60a for switching the air-conditioner on and off (specifically the compressor 11 on and off), an auto switch for setting and releasing automatic control of the vehicular air-conditioning system 1 (not shown), an operating mode switch (not shown), a suction port mode switch 60b for switching the suction port mode, a vent mode switch 60c for switching the vent mode, a flow rate setting switch of the blower 32 (not shown), a cabin temperature setting switch (not shown), an economy switch outputting a command giving priority to power saving in the refrigeration cycle (not shown), etc. are provided.

Next, using FIG. 6, the operation of the present embodiment in the above constitution will be explained. FIG. 6 is a flowchart showing the control processing of a vehicular air-conditioning system 1 of the present embodiment. This control processing is executed by power being supplied from the battery to the air-conditioning control device 50 even when the vehicle system is at a stop.

First, at step S1, it is judged if a starter switch of pre-air-conditioning or an operating switch of the vehicular air-conditioning system 1 of the operating panel 60 is switched to “on”. If the starter switch of pre-air-conditioning or the operating switch of the vehicular air-conditioning system 1 is switched to “on”, the routine proceeds to step S2.

Note that, “pre-air-conditioning” is air-conditioning control for starting air-conditioning in the cabin before a passenger gets into the vehicle. The starter switch of the pre-air-conditioning is provided at a wireless terminal (remote controller) carried by the passenger. Therefore, the passenger-can start the vehicular air-conditioning system 1 from a location separated from the vehicle.

Furthermore, in the hybrid vehicle to which the vehicular air-conditioning system 1 of the present embodiment is applied, it is possible to charge the battery by supplying power to the battery from a commercial power source (external power supply). Therefore, pre-air-conditioning may be performed for exactly a predetermined time (for example, 30 minutes) when the vehicle is connected to an outside power source and be performed until the remaining battery life falls to a predetermined level or less when not connected to an outside power source.

At step S2, the flags, timers, etc. are initialized and the stepping motor forming above-mentioned electric actuator is set to the initial position. At the next step S3, the operating signals of the operating panel 60 are read and the routine proceeds to step S4. As specific operating signals, there are the cabin temperature setting Tset set by a cabin temperature setting switch, vent mode selection signal, suction port mode selection signal, setting signal of the flow rate of the blower 32, etc.

At step S4, the signals of the vehicle environment conditions used for air-conditioning control, that is, the detection signals of the above-mentioned group of sensors 51 to 57, are read, then the routine proceeds to step S5. At step S5, the target blowing temperature TAO of the cabin vented air is calculated. Furthermore, in the heating mode, the heating use heat exchanger target temperature is calculated. The target blowing temperature TAO is calculated by the following formula F1:

TAO=Kset×Tset−Kr×Tr−Kam×Tam−Ks×Ts+C (F1)

where, Tset is the cabin temperature setting set by a cabin temperature setting switch, Tr is a cabin temperature (inside air temperature) detected by the inside air sensor 51, Tam is an outside air temperature detected by the outside air sensor 52, and Ts is an amount of sunlight detected by a sunlight sensor 53. Kset, Kr, Kam, and Ks are control gains, while C is a correction use constant.

Further, the heating use heat exchanger target temperature basically becomes the value calculated by the above-mentioned formula F1, but to keep down power consumption, it is sometimes corrected to a value lower than the TAO calculated by the formula F1.

At the next steps S6 to S16, the control states of the various types of devices connected to the air-conditioning control device 50 are determined. First, at step S6, in accordance with the state of the air-conditioned environment, the cooling mode, heating mode, first drying mode, and second drying mode are selected and activation of the PTC heaters 37 is determined. The more detailed content of step S6 of the present embodiment will be explained later.

At step S7, the target blowing rate of the air blown from the blower 32 is determined. Specifically, the blower motor voltage applied to the electric motor is determined based on the TAO determined at step S4 with reference to a control map stored in advance in the air-conditioning control device 50.

Specifically, in the present embodiment, in the extremely low temperature region (maximum cooling region) and extremely high temperature region (maximum heating region) of the TAO, the blower motor voltage is made a high voltage near the maximum value to control the flow rate of the blower 32 to close to the maximum flow rate. Further, if TAO rises from the extremely low temperature region toward the intermediate temperature region, the blower motor voltage is reduced to reduce the flow rate of the blower 32 in accordance with the rise of the TAO.

Furthermore, if TAO falls from the extremely high temperature region to the intermediate temperature region, the blower motor voltage is reduced to reduce the flow rate of the blower 32 in accordance with the drop in the TAO. Further, if TAO enters the predetermined intermediate temperature, the blower motor voltage is made the minimum value to make the flow rate of the blower 32 the minimum value.

At step S8, the suction port mode, that is, the switched state of the inside/outside air switching box 40, is determined. This suction port mode is also determined based on the TAO with reference to a control map stored in advance in the air-conditioning control device 50. In the present embodiment, basically, the outside air mode for introducing outside air is given priority to, but when TAO is an extremely low temperature region and a high cooling performance is desired to be obtained etc., the inside air mode for introducing inside air is selected. Furthermore, it is also possible to provide an exhaust gas concentration detecting means for detecting the exhaust gas concentration of the outside air and to select the inside air mode when the exhaust gas concentration is a predetermined reference concentration or more.

At step S9, the vent mode is determined. This vent mode is also determined based on the TAO with reference to a control map stored in advance in the air-conditioning control device 50. In the present embodiment, as the TAO rises from the low temperature region to the high temperature region, the vent mode is successively switched from the foot mode→bilevel mode→face mode.

Therefore, in the summer, the face mode is mainly selected, in the spring and fall, the bilevel mode is mainly selected, and in the winter, the foot mode is mainly selected. Furthermore, when there is a high possibility of fogging of the window glass from the detection value of the humidity sensor, the foot and defroster mode or defroster mode may be selected.

At step S10, the target opening degree SW of the air mix door 38 is calculated based on the above TAO, temperature TE of air blown from the inside evaporator 26 detected by the evaporator temperature sensor 56, and heater temperature.

Here, the “heater temperature” is a value determined in accordance with the heating ability of the heating means arranged in the heating use cool air passage 33 (heater core 36, inside condenser 12, and PTC heaters 37). Specifically, the engine cooling water temperature Tw can be employed. Therefore, the target opening degree SW is calculated by the following formula F2:

SW=[(TAO−TE)/(Tw−TE)]×100(%) (F2)

where, SW=0 (%) is the maximum cooling position of the air mix door 38. The cool air bypass passage 34 is opened wide and the heating use cool air passage 33 is fully closed. As opposed to this, SW=100 (%) is the maximum heating position of the air mix door 38. The cool air bypass passage 34 is fully closed and the heating use cool air passage 33 is opened wide.

At step S11, the refrigerant discharge ability of the compressor 11 (specifically, the speed) is determined. The basic method of determination of the speed of the compressor 11 of the present embodiment is as follows. For example, in the cooling mode, the target blowing temperature TEO of the temperature TE of air blown from the inside evaporator 26 is determined based on the TAO determined at step S4 etc. referring to a control map stored in advance in the air-conditioning control device 50.

Further, an error En (TEO-TE) of this target blowing temperature TEO and blown air temperature TE is calculated. This error En and a rate of change of error Edot (En−(En−1)) obtained by subtracting from the currently calculated error En the previously calculated error En−1 are used to find the change of speed ΔfC with respect to the previous compressor speed fCn−1 based on fuzzy logic based on a membership function and rules stored in advance in the air-conditioning control device 50.

Further, in the heating mode, the target high pressure PDO of the discharge refrigerant pressure Pd is determined based on the heating use heat exchanger target temperature determined at step S4 etc. referring to the control map stored in advance in the air-conditioning control device 50. The error Pn (PDO−Pd) of this target high pressure PDO and the discharge refrigerant pressure Pd is calculated. Furthermore, this error Pn and the change of error Pdot (Pn−(Pn−1)) with respect to the previously calculated error Pn−1 are used to find the change of speed ΔfH from the previous compressor speed fHn−1 based on fuzzy logic.

At step S12, the operating rate of the blowing fan 16a blowing outside air toward the outside heat exchanger 16 is determined. The basic method of determination of the operating rate of the blowing fan 16a in the present embodiment is as follows: That is, a first provisional operating rate is determined so that the operating rate of the blowing fan 16a increases along with an increase of the discharge refrigerant temperature Td of the compressor 11, then a second provisional operating rate is determined so that the operating rate of the blowing fan 16a increases along with a rise of the engine cooling water temperature Tw.

Furthermore, the larger of the first and second provisional operating rates is selected, the selected operating rate is corrected considering the reduction of noise of the blowing fan 16a and the vehicle speed, and the corrected value is determined as the operating rate of the blowing fan 16a. The more detailed content of step S12 of the present embodiment will be explained later.

At step S13, the number of operating PTC heaters 37 is determined and the operating state of the electric heating defogger 47 is determined. The number of operating PTC heaters 37 may be determined in accordance with the difference between the inside air temperature Tr and heating use heat exchanger target temperature when the heating use heat exchanger target temperature cannot be obtained even when the target opening degree SW of the air mix door 38 at the time of the heating mode becomes 100% when for example, at step S6, activation of the PTC heaters 37 is considered required.

Further, when there is a high possibility of fogging of the window glass due to the humidity and temperature in the cabin or when the window glass is fogged up, the electric heating defogger 47 is operated.

Next, at step S14, in accordance with the operating mode determined at the above-mentioned step S6, the operating states of the refrigerant circuit switching means constituted by the solenoid valves 13, 17, 20, 21, and 24 are determined. At this time, in the present embodiment, to realize a refrigerant circuit in accordance with the cycle, the solenoid valves are controlled so that basically the refrigerant flow path over which the refrigerant flows becomes opened. For refrigerant flow paths where refrigerant will not flow due to the relative pressures of the refrigerant pressure, the solenoid valves are deactivated so as to keep down the power consumption.

Details of step S14 will be explained using FIG. 7. First, at step S141, the operating mode determined at step S6 is read into the memory CYCLE VALVE. Next, at step S142, it is judged if the vehicular air-conditioning system 1 is stopped, that is, whether not to air-condition the inside of the cabin.

When it is judged at step S142 that the vehicular air-conditioning system 1 is stopped, at step S143, the memory CYCLE VALVE is set to the cooling mode (COOL cycle) and the routine proceeds to step S144. At step S143, when it is judged that the vehicular air-conditioning system 1 is not stopped, the routine proceeds to step S144.

At step S144, the operating states of the solenoid valves 13, 17, 20, 21, and 24 are determined. Specifically, when the memory CYCLE VALVE is set to the cooling mode (COOL cycle), all of the solenoid valves are made deactivated. Further, when the memory CYCLE VALVE is set to the cooling mode (HOT cycle), the electrical three-way valve 13, high pressure solenoid valve 20, and low pressure solenoid valve 17 are activated and the remaining solenoid valves 21 and 24 are deactivated. Further, when the memory CYCLE VALVE is set to the first drying mode (DRY EVA cycle), the electrical three-way valve 13, low pressure solenoid valve 17, drying solenoid valve 24, and heat exchanger cutoff solenoid valve 21 are activated and the high pressure solenoid valve 20 is deactivated. Further, when the memory CYCLE VALVE is set to the second drying mode (DRY ALL cycle), the electrical three-way valve 13, low pressure solenoid valve 17, and drying solenoid valve 24 are activated and the remaining solenoid valves 20 and 21 are deactivated.

That is, in the present embodiment, no matter what operating mode of the refrigerant circuit is switched to, the supply of power to at least one solenoid valve among the solenoid valves 13, 17, 20, 21, and 24 is stopped.

At step S15, the presence of a request for operation of the engine EG is determined. Here, in a usual vehicle obtaining drive power for operating the vehicle from only the engine EG, the engine is constantly running so the engine cooling water also constantly becomes a high temperature. Therefore, in a usual vehicle, the engine cooling water may be run through the heater core 36 to obtain a sufficient heating performance.

As opposed to this, in a hybrid vehicle like the present embodiment, if there is sufficient margin in the remaining battery life, it is possible to obtain the drive force just from the drive-use electric motor. For this reason, even when a high heating performance is required, if the engine EG stops, the engine cooling water temperature will only rise to 40° C. and therefore a sufficient heating performance will no longer be able to be exhibited by the heater core 36.

Therefore, in the present embodiment, heating is performed by the heat pump cycle so as to enable the heat source required for heating to be secured even when the engine cooling water temperature is low. However, in a vehicular air-conditioning system, performing the heating by a heat pump cycle involves various problems in practice.

For example, there is the problem that the heat pump cycle ends up falling in efficiency when the outside air temperature is considerably low. Further, in a refrigeration cycle 10 designed to enable drying by the heat pump cycle as in the present embodiment, since the drying ability of the heat pump cycle is inferior to the drying ability of the cooler cycle, there is the problem that the defogging ability is also inferior.

Due to such practical problems, if selecting the heat pump cycle and problems arise, in the same way as a usual vehicle, heating by the heater core 36 or drying heating by the cooler cycle and heater core 36 together becomes necessary.

Therefore, to secure the heat source required for heating by the heater core 36, when the engine cooling water temperature Tw is lower that a predetermined reference cooling water temperature even when a high heating performance is necessary, the air-conditioning control device 50 outputs to the engine control device used for control of the engine EG (not shown) a signal requesting operation of the engine EG.

Due to this, the engine cooling water temperature Tw is raised to obtain a high heating performance. Note that, this engine EG operation request signal causes the engine EG to operate even when it is not necessary to operate the engine as a source of drive power for the vehicle, so becomes a cause of poorer vehicle fuel economy. For this reason, the frequency of outputting this engine EG operation request signal is preferably kept as low as possible.

At step S16, when frost forms on the outside heat exchanger 16, control is performed to remove the frost from the outside heat exchanger 16. Here, it is known that when, like with the refrigerant circuit of the heating mode, the refrigerant is made to perform a heat absorbing action at the outside heat exchanger 16, if the refrigerant evaporation temperature at the outside heat exchanger 16 falls to −12° C. or so, frost will form on the outside heat exchanger 16.

If such frost forms, cabin outside air will no longer flow in the outside heat exchanger 16 and the outside heat exchanger 16 will no longer be able to perform heat exchange between the refrigerant and cabin outside air. For this reason, when frost forms on the outside heat exchanger 16, control processing is performed for forcibly switching to the cooling mode. As explained later, in the refrigerant circuit of the cooling mode, the refrigerant releases heat in the outside heat exchanger 16, so frost formed at the outside heat exchanger 16 can be melted.

At step S17, the air-conditioning control device 50 outputs control signals and control voltages to the various types of devices 61, 13, 17, 20, 21, 24, 16a, 32, 62, 63, and 64 so that the control states determined at the above-mentioned steps S6 to S16 are obtained. For example, a control signal is output to the inverter 61 of the electric motor 11b of the compressor 11 so that the speed of the compressor 11 becomes a speed determined at step S11.

At the next step S18, the system waits for the control period τ. When judging that the control period τ has elapsed, the routine returns to step S3. Note that, in the present embodiment, the control period τ is made 250 ms. This is because in the air-conditioning control in the cabin, even a control period later than the engine control etc. will not have a detrimental effect on the control characteristics. Furthermore, it is possible to keep down the amount of communication for air-conditioning control in the vehicle and sufficiently secure the amount of communication of the control system required for high speed control such as engine control.

Next, the more detailed content of the above-mentioned step S6 will be explained. FIG. 9(a) is a flowchart showing the main parts of step S6. The control processing of the flowchart of FIG. 9(a) is executed when the air-conditioner switch 60a and the auto switch are turned “on” etc.

In the flowchart of FIG. 9(a), the drying ability is improved and the vented air temperature is raised to improve the defogging ability (steps S33 and S35).

First, at step S30, it is judged if the cooler cycle (cooling mode) has been selected. When it is judged that the mode is other than the cooler cycle (case of NO judgment), the routine proceeds to step S31 where it is judged if the vent mode is DEF and manual F/D, that is, if the vent mode switch 60c has been manually operated (operated by a passenger) to set the defroster mode or foot and defroster mode (defogging mode).

When it is judged at step S31 that the mode is DEF and manual F/D (case of YES judgment), the routine proceeds to step S32 where it is judged if there is the possibility of window fogging. In the present embodiment, when the window glass surface relative humidity RHW is higher than 90 (RHW>90), it is judged that there is the possibility of window fogging.

Here, the window glass surface relative humidity RHW is calculated using the relative humidity of the cabin air near the window glass, the temperature of the cabin air near the window glass, window glass surface temperature (window glass inside side surface temperature), and a moist air graph stored in advance in the air-conditioning control device 50. In this embodiment, the window glass surface relative humidity RHW is calculated based on the detection values of the RHW sensor 45 arranged at the window glass surface.

When it is judged at step S32 that the window glass surface relative humidity RHW is higher than 90 (case of YES judgment), it is judged that there is the possibility of window fogging and the routine proceeds to step S33 where it is decided to request operation of the engine EG (ON request) so as to raise the engine cooling water temperature Tw.

Next, at step S34, it is judged if the vented air of the target blowing temperature TAO can be prepared by the engine cooling water, in other words, if the engine cooling water temperature Tw is higher than a predetermined temperature.

In the present embodiment, when the engine cooling water temperature Tw is higher than an inside condenser target temperature (inside condenser target temperature) (engine cooling water temperature>inside condenser target temperature), it is judged that the vented air of the target blowing temperature TAO can be prepared by the engine cooling water. Incidentally, the inside condenser target temperature is basically the same as the above-mentioned heating use heat exchanger target temperature, but sometimes the heating use heat exchanger target temperature is corrected somewhat.

When the engine cooling water temperature Tw is higher than the inside condenser target temperature (inside condenser target temperature) (case of YES judgment), the routine proceeds to step S35 where the cooler cycle (cooling mode) is selected. Due to this, a strong drying operation is performed in the cooler cycle and heating is performed by the heater core 36. Note that, when giving priority to drying over the feeling of warmth of the passengers, the processing of step S34 may also be omitted.

When at step S34 the engine cooling water temperature Tw is the inside condenser target temperature (inside condenser target temperature) or less (case of NO judgment), it is judged that the vented air of the target blowing temperature TAO cannot be prepared by the engine cooling water and the routine proceeds to step S36 where the heat pump cycle is selected.

Further, when at step S32 the window glass relative humidity RHW is 90 or less (case of NO judgment), the routine proceeds to step S36 for selection of the heat pump cycle. That is, in this case, regardless of there being no possibility of window fogging, the passenger has set the DEF and manual F/D, so it is judged that the DEF and manual F/D operation by the passenger is a mistake and an operation to prevent fogging, so the heat pump cycle where the drying ability is inferior to that of the cooler cycle is selected.

Further, even when at step S31 the mode is other than DEF and manual F/D (case of NO judgment), the routine proceeds to step S36 for selection of the heat pump cycle. That is, when other than DEF and manual F/D, it is judged that there is low urgency for defogging and the heat pump cycle where the drying ability is inferior to that of the cooler cycle is selected.

At step S36, it is judged if there is a high possibility of window fogging. In the present embodiment, when the window glass surface relative humidity RHW is higher than 100 (RHW>100), it is judged that there is a high possibility of window fogging.

When the window glass surface relative humidity RHW is higher than 100 (case of YES judgment), it is judged that there is a high possibility of window fogging and the routine proceeds to step S37 where the need for drying (degree of need for drying) is judged based on the evaporator temperature TE. More specifically, the higher the evaporator temperature TE, the greater the need for drying judged, while the lower the evaporator temperature TE, the less the need for drying judged.

In the present embodiment, the need for drying is judged based on the map of FIG. 9(b). In the map of FIG. 9(b), to control the evaporator temperature TE to about 2° C., the abscissa of the map of FIG. 9(b) is made 2-TE and the degree of need of drying is judged in accordance with the value of 2-TE. Incidentally, the hysteresis in the map of FIG. 9(b) is set to prevent control hunting.

When it is judged that drying is necessary (need is large), the routine proceeds to step S38 where the DRY EVA cycle (first drying mode) with the highest drying ability in the heat pump cycle is selected.

Further, when it is judged that the need for drying is small, the routine proceeds to step S39 where the DRY ALL cycle (second drying mode) where the drying ability is inferior to the DRY EVA cycle, but the heating ability is high is selected.

Further, when it is judged that there is no need for drying, the routine proceeds to step S40 where the HOT cycle (heating mode) where there is no drying ability, but where the heating ability is the highest is selected.

Due to the processing of steps S37 to S40, the drying ability of the heat pump cycle is adjusted in accordance with the degree of need for drying.

On the other hand, when at step S36 the window glass surface relative humidity RHW is 100 or less (case of NO judgment), it is judged that there is a low possibility of window fogging and the routine proceeds to step S40 where the HOT cycle (heating mode) where there is no drying ability, but the heating ability is the highest is selected.

Note that, the above-mentioned step S32 is not necessarily required. Step S32 may be omitted. That is, when it is judged at step S31 that the mode is DEF and manual F/D, it is also possible to proceed, regardless of the possibility of window fogging, to step S33 where it is decided to request operation of the engine EG (ON request) and, furthermore, to step S35 where the cooler cycle is selected.

The vehicular air-conditioning system 1 of the present embodiment is controlled as explained above, so operates as follows in accordance with the operating mode selected at the control step S6.

(a) Cooling Mode (COOL Cycle: see FIG. 1)

In the cooling mode, the air-conditioning control device 50 deactivates all of the solenoid valves, so the electrical three-way valve 13 connects the refrigerant outlet side of the inside condenser 12 and one refrigerant flow inlet/outlet of the first three-way coupling 15, the low pressure solenoid valve 17 closes, the high pressure solenoid valve 20 opens, the heat exchanger cutoff solenoid valve 21 opens, and the drying solenoid valve 24 closes.

Due to this, as shown by the arrow of FIG. 1, a vapor compression type refrigeration cycle is formed where the refrigerant circulates in the order of compressor 11→inside condenser 12→electrical three-way valve 13→first three-way coupling 15→outside heat exchanger 16→second three-way coupling 19→high pressure solenoid valve 20→second check valve 22→variable venturi mechanism 27b of temperature type expansion valve 27→fourth three-way coupling 25→inside evaporator 26→feeler bulb 27a of temperature type expansion valve 27→fifth three-way coupling 28→accumulator 29→compressor 11.

In the refrigerant circuit of this cooling mode, refrigerant flowing in from the electrical three-way valve 13 to the first three-way coupling 15 will never flow out to the low pressure solenoid valve 17 side since the low pressure solenoid valve 17 is closed. Further, the refrigerant flowing in from the outside heat exchanger 16 to the second three-way coupling 19 will never flow out to the heat exchanger cutoff solenoid valve 21 side since the drying solenoid valve 24 is closed. Further, the refrigerant flowing out from the variable venturi mechanism 27b of the temperature type expansion valve 27 will never flow out to the drying solenoid valve 24 side since the drying solenoid valve 24 is closed. Furthermore, the refrigerant flowing in from the feeler bulk 27a of the temperature type expansion valve 27 to the fifth three-way coupling 28 will never flow out to the second check valve 22 side due to the action of the second check valve 22.

Therefore, the refrigerant compressed at the compressor 11 is cooled at the inside condenser 12 by heat exchange with the vented air (cool air) after passing through the inside evaporator 26, is further cooled by heat exchange with the outside air at the outside heat exchanger 16, and is reduced in pressure and expanded by the temperature type expansion valve 27. The low pressure refrigerant reduced in pressure by the temperature type expansion valve 27 flows into the inside evaporator 26 and evaporates by absorbing heat from the vented air blown from the blower 32. Due to this, the vented air passing through the inside evaporator 26 is cooled.

At this time, as explained above, the opening degree of the air mix door 38 is adjusted, so part (or all) of the vented air cooled at the inside evaporator 26 flows from the cool air bypass passage 34 to the mixing space 35, while part (or all) of the vented air cooled at the inside evaporator 26 flows into the heating use cool air passage 33, passes through the heater core 36, inside condenser 12, and heater core 36 during which it is reheated, and flows into the mixing space 35.

Due to this, the temperature of the vented air mixed in the mixing space 35 and blown out into the cabin is adjusted to the desired temperature to thereby enable the inside of the cabin to be cooled. Note that, in the cooling mode, the drying ability of the vented air is also high, but almost no heating ability is exhibited.

Further, the refrigerant flowing out from the inside evaporator 26 flows via the feeler bulb 27a of the temperature type expansion valve 27 to the accumulator 29. The gaseous phase refrigerant separated at the accumulator 29 is sucked into the compressor 11 and again compressed.

(b) Heating Mode (HOT Cycle: see FIG. 2)

In the heating mode, the air-conditioning control device 50 activates the electrical three-way valve 13, high pressure solenoid valve 20, and low pressure solenoid valve 17 and deactivates the remaining solenoid valves 21 and 24, so the electrical three-way valve 13 connects the refrigerant outlet side of the inside condenser 12 and the refrigerant inlet side of the fixed venturi 14, the low pressure solenoid valve 17 opens, the high pressure solenoid valve 20 closes, the heat exchanger cutoff solenoid valve 21 opens, and the drying solenoid valve 24 closes.

Due to this, as shown by the arrow of FIG. 2, a vapor compression type refrigeration cycle is formed in which the refrigerant circulates in the order of the compressor 11→inside condenser 12→electrical three-way valve 13→fixed venturi 14→third three-way coupling 23→heat exchanger cutoff solenoid valve 21→second three-way coupling 19→outside heat exchanger 16→first three-way coupling 15→low pressure solenoid valve 17→first check valve 18→fifth three-way coupling 28→accumulator 29→compressor 11.

In the refrigerant circuit of this heating mode, the refrigerant flowing in from the fixed venturi 14 to the third three-way coupling 23 will never flow out to the drying solenoid valve 24 side since the drying solenoid valve 24 is closed. Further, the refrigerant flowing in from the heat exchanger cutoff solenoid valve 21 to the second three-way coupling 19 will never flow out to the high pressure solenoid valve 20 side since the high pressure solenoid valve 20 is closed. Further, the refrigerant flowing from the outside heat exchanger 16 to the first three-way coupling 15 will never flow out to the electrical three-way valve 13 side since the electrical three-way valve 13 connects the refrigerant outlet side of the inside condenser 12 and the refrigerant inlet side of the fixed venturi 14. The refrigerant flowing from the first check valve 18 to the fifth three-way coupling 28 will never flow out to the temperature type expansion valve 27 side since the drying solenoid valve 24 is closed.

Therefore, refrigerant compressed at the compressor 11 is cooled at the inside condenser 12 by heat exchange with the vented air blown from the blower 32. Due to this, the vented air passing through the inside condenser 12 is heated. At this time, the opening degree of the air mix door 38 is adjusted and, in the same way as the cooling mode, the temperature of the vented air mixed in the mixing space 35 and blown out into the cabin is adjusted to the desired temperature so the inside of the cabin can be cooled. Note that, in the heating mode, the drying ability of the vented air is not exhibited.

Further, the refrigerant flowing out from the inside condenser 12 is reduced in pressure at the fixed venturi 14 and flows into the outside heat exchanger 16. The refrigerant flowing into the outside heat exchanger 16 evaporates by absorbing heat from the cabin outside air blown from the blowing fan 16a. The refrigerant flowing out from the outside heat exchanger 16 flows through the low pressure solenoid valve 17, first check valve 18, etc. into the accumulator 29. The gaseous phase refrigerant separated at the accumulator 29 is sucked into the compressor 11 and again compressed.

(c) First Drying Mode (DRY EVA Cycle: see FIG. 3)

In the first drying mode, the air-conditioning control device 50 activates the electrical three-way valve 13, low pressure solenoid valve 17, heat exchanger cutoff solenoid valve 21, and drying solenoid valve 24 and deactivates the high pressure solenoid valve 20, so the electrical three-way valve 13 connects the refrigerant outlet side of the inside condenser 12 and the refrigerant inlet side of the fixed venturi 14, the low pressure solenoid valve 17 opens, the high pressure solenoid valve 20 opens, the heat exchanger cutoff solenoid valve 21 closes, and the drying solenoid valve 24 opens.

Due to this, as shown by the arrow of FIG. 3, a vapor compression type refrigeration cycle is formed where the refrigerant circulates in the order of the compressor 11→inside condenser 12→electrical three-way valve 13→fixed venturi 14→third three-way coupling 23→drying solenoid valve 24→fourth three-way coupling 25→inside evaporator 26→feeler bulb 27a of temperature type expansion valve 27→fifth three-way coupling 28→accumulator 29→compressor 11.

In the refrigerant circuit of this first drying mode, the refrigerant flowing in from the fixed venturi 14 to the third three-way coupling 23 will never flow out to the heat exchanger cutoff solenoid valve 21 side since the heat exchanger cutoff solenoid valve 21 is closed. Further, the refrigerant flowing in from the drying solenoid valve 24 to the fourth three-way coupling 25 will never flow out to the variable venturi mechanism 27b side of the temperature type expansion valve 27 due to the action of the second check valve 22. Further, the refrigerant flowing in from the feeler bulb 27a of the temperature type expansion valve 27 to the fifth three-way coupling 28 will never flow out to the first check valve 18 side due to the action of the first check valve 18.

Therefore, the refrigerant compressed at the compressor 11 is cooled by heat exchange with the vented air (cool air) after passing through the inside evaporator 26 at the inside condenser 12. Due to this, the vented air passing through the inside condenser 12 is heated. The refrigerant flowing out from the inside condenser 12 is reduced in pressure at the fixed venturi 14 and flows into the inside evaporator 26.

The low pressure refrigerant flowing into the inside evaporator 26 absorbs heat from the vented air blown from the blower 32 and generates heat. Due to this, the vented air passing through the inside evaporator 26 is cooled and dried. Therefore, the vented air cooled and dried at the inside evaporator 26 is reheated when passing through the heater core 36, inside condenser 12, and heater core 36 and is blown out from the mixing space 35 into the cabin. That is, a drying operation can be performed in the cabin. Note that, in the first drying mode, a drying ability of the vented air can be exhibited, but the heating ability is small.

Further, the refrigerant flowing out from the inside evaporator 26 flows into the accumulator 29 via the feeler bulb 27a of the temperature type expansion valve 27. The gaseous phase refrigerant separated at the accumulator 29 is sucked into the compressor 11 where it is again compressed.

(d) Second Drying Mode (DRY ALL Cycle: see FIG. 4)

In the second drying mode, the air-conditioning control device 50 activates the electrical three-way valve 13, low pressure solenoid valve 17, and drying solenoid valve 24 and deactivates the remaining solenoid valves 20 and 21, so the electrical three-way valve 13 connects the refrigerant outlet side of the inside condenser 12 and the refrigerant inlet side of the fixed venturi 14, the low pressure solenoid valve 17 opens, the high pressure solenoid valve 20 opens, the heat exchanger cutoff solenoid valve 21 opens, and the drying solenoid valve 24 opens.

Due to this, a vapor compression type refrigeration cycle is formed where, as shown by the arrow in FIG. 4, refrigerant circulates in the order of the compressor 11→inside condenser 12→electrical three-way valve 13→fixed venturi 14→third three-way coupling 23→heat exchanger cutoff solenoid valve 21→second three-way coupling 19→outside heat exchanger 16→first three-way coupling 15→low pressure solenoid valve 17→first check valve 18→fifth three-way coupling 28→accumulator 29→compressor 11 and where the refrigerant circulates in the order of compressor 11→inside condenser 12→electrical three-way valve 13→fixed venturi 14→third three-way coupling 23→drying solenoid valve 24→fourth three-way coupling 25→inside evaporator 26→feeler bulb 27a of temperature type expansion valve 27→fifth three-way coupling 28→accumulator 29→compressor 11.

That is, in the second drying mode, the refrigerant flowing in from the fixed venturi 14 to the third three-way coupling 23 flows out to both the heat exchanger cutoff solenoid valve 21 side and drying solenoid valve 24 side. Both the refrigerant flowing in from the first check valve 18 to the fifth three-way coupling 28 and the refrigerant from in from the feeler bulb 27a of the temperature type expansion valve 27 to the fifth three-way coupling 28 merge at the fifth three-way coupling 28 and flow out to the accumulator 29 side.

Note that, in the refrigerant circuit of this second drying mode, the refrigerant flowing in from the outside heat exchanger 16 to the first three-way coupling 15 will never flow out to the electrical three-way valve 13 side since the electrical three-way valve 13 connects the refrigerant outlet side of the inside condenser 12 and the refrigerant inlet side of the fixed venturi 14. Further, the refrigerant flowing in from the drying solenoid valve 24 to the fourth three-way coupling 25 will never flow out to the variable venturi mechanism 27b side of the temperature type expansion valve 27 due to the action of the second check valve 22.

Therefore, the refrigerant compressed at the compressor 11 is cooled at the inside condenser 12 by being exchanged in heat with the vented air (cool air) after passing through the inside evaporator 26. Due to this, the vented air passing through the inside condenser 12 is heated. The refrigerant flowing out from the inside condenser 12 is reduced in pressure at the fixed venturi 14, then is branched at the third three-way coupling 23 and flows into the outside heat exchanger 16 and the inside evaporator 26.

The refrigerant flowing into the outside heat exchanger 16 evaporates while absorbing heat from the air outside the cabin blown from the blowing fan 16a. The refrigerant flowing out from the outside heat exchanger 16 flows through the low pressure solenoid valve 17, first check valve 18, etc. to the fifth three-way coupling 28. The low pressure refrigerant flowing into the inside evaporator 26 evaporates while absorbing heat from the vented air blown from the blower 32. Due to this, the vented air passing through the inside evaporator 26 is cooled and dried.

Therefore, the vented air cooled and dried at the inside evaporator 26 is reheated while passing through the heater core 36, inside condenser 12, and heater core 36 and is blown out from the mixing space 35 to the inside of the cabin. At this time, in the second drying mode, the amount of heat absorbed by the outside heat exchanger 16 for the first drying mode can be released by the inside condenser 12, so the vented air can be heated to a higher temperature than in the first drying mode. That is, in the second drying mode, drying heating can be performed where a high heating ability is exhibited while a drying ability is also exhibited.

Further, the refrigerant flowing out from the inside evaporator 26 flows into the fifth three-way coupling 28 where it merges with the refrigerant flowing out from the outside heat exchanger 16 and flows into the accumulator 29. The gaseous phase refrigerant separated at the accumulator 29 is sucked into the compressor 11 where it is again compressed.

As explained above, in the present embodiment, it is possible to improve the practicality of the vehicular air-conditioning system 1. Specifically, when, like in steps S31 and S33, the mode is DEF and manual F/D, the engine EG is operated to set the cooler cycle (cooling mode), so it is possible to improve the drying ability and possible to raise the vented air temperature and in turn possible to improve the defogging ability. Further, by selecting the cooler cycle, it is possible to prevent the formation of frost on the outside heat exchanger 16, so the formation of frost will not end up causing a drop in the defogging ability like with the drying heat pump cycle.

Further, as shown in step S34, the heat pump cycle is continued until the engine cooling water temperature Tw becomes sufficiently higher, so when the mode is DEF and manual F/D, low temperature air being vented and the feeling of warmth of the passengers dropping can be prevented.

Further, as shown in steps S32 and S33, when there is a (high) possibility of window fogging, the engine EG is operated, so operation of the engine EG can be prevented when there is no (low) possibility of window fogging. For this reason, it is possible to reduce the frequency of operation of the internal combustion engine (EG), so it is possible to improve the vehicle fuel economy and reduce exhaust gas emissions.

Further, as shown in steps S32 and S35, when there is a (high) possibility of window fogging, the cooler cycle is selected, so selection of the cooler cycle can be prevented when there is no (low) possibility of window fogging. For this reason, at the time of DEF and manual F/D, low temperature air being vented and the feeling of warmth of the passengers dropping can be prevented more.

### Second Embodiment

FIG. 10 is a flowchart showing main parts of step S6 in the present second embodiment. The control processing of the flowchart of FIG. 10 is executed when the air-conditioner switch 60a and auto switch are on (ON) etc.

First, at step S60, it is judged if the time is that for pre-air-conditioning. When it is judged that the time is that for pre-air-conditioning (case of YES judgment), the routine proceeds to step S61 where it is judged if the outside air temperature is lower than a predetermined threshold value (in the example of FIG. 10, −3° C.)

When it is judged that the outside air temperature is lower than a predetermined threshold value (case of YES judgment), the routine proceeds to step S62 where it is decided to activate the PTC heaters 37. That is, at the time of pre-air-conditioning, the power switch of the hybrid system of the vehicle is off (OFF) in state, so the engine EG cannot be started up. For this reason, it is not possible to raise the cooling water temperature, so it is not possible to use the heater core 36 for heating.

Further, when the outside air temperature is considerably low, the efficiency of the heat pump cycle is poor and, also, frost easily forms on the outside heat exchanger 16. From the above reasons, at step S62, the PTC heaters 37 are selected as the heating means.

When it is judged at step S61 that the outside air temperature is a predetermined threshold value or more (case of NO judgment), the routine proceeds to step S63 where it is judged if the auto vent is the face (FACE), that is, if the determination of the vent mode based on the TAO (see step S9) resulted in the face mode.

When it is judged that the auto vent is the face (case of YES judgment), the routine proceeds to step S64 where the cooler cycle (cooling mode) is selected. That is, as explained at step S9, the vent mode is determined to be the face mode when TAO is a low temperature region, so in this case, it is judged that heating by the heat pump cycle is not necessary and cooling by the cooler cycle (pre-air-conditioning) is selected.

When it is judged at step S63 that the auto vent is not the face (case of NO judgment), the routine proceeds to step S65 for selection of the heat pump cycle.

On the other hand, when it is judged at step S60 that the operation is other than pre-air-conditioning, that is, at the time of normal air-conditioning, the routine proceeds to step S66 where it is judged if the outside air temperature is lower than a predetermined threshold value (in the example of FIG. 10, −3° C.)

When it is judged that the outside air temperature is lower than a predetermined threshold value (case of YES judgment), the routine proceeds to step S67 where the cooler cycle is selected and it is decided to request operation of the engine EG (ON request).

That is, at the time of usual air-conditioning, the power switch of the hybrid system of the vehicle is “on” in state, so the engine EG can be operated. Therefore, the engine EG is operated to make the engine cooling water a high temperature to select heating (drying heating) by a combination of the cooler cycle and heater core 36.

When it is judged at step S66 that the outside air temperature is the predetermined threshold value or more (case of NO judgment), the routine proceeds to step S68 where it is judged if the auto vent is the face (FACE).

When it is judged that the auto vent is the face (case of YES judgment), the routine proceeds to step S69 where cooling by the cooler cycle is selected. The reason is similar to that of step S64.

When it is judged at step S68 that the auto vent is not the face (case of NO judgment), the routine proceeds to step S65 for selection of the heat pump cycle.

At step S65, it is judged if there is a high possibility of window fogging. In the present embodiment, when the window glass surface relative humidity RHW is higher than 100 (RHW>100), it is judged that there is a high possibility of window fogging.

When it is judged that the window glass surface relative humidity RHW is higher than 100 (case of YES judgment), it is judged that there is a high possibility of window fogging and the routine proceeds to step S70 where the need for drying is judged based on the evaporator temperature TE.

Step S70 is the same as step S37 of FIG. 9. In accordance with the need for drying, the DRY EVA cycle (step S71), DRY ALL cycle (step S72), and HOT cycle (step S73) are selected. Due to this, the drying ability of the heat pump cycle is adjusted in accordance with the need for drying.

When it is judged at step S65 that the window glass surface relative humidity RHW is 100 or less (case of NO judgment), it is judged that there is a high possibility of window fogging and the routine proceeds to step S74 where it is judged if the vent mode is DEF and manual F/D.

When it is judged that the vent mode is DEF and manual F/D (case of YES judgment), it is judged that there is a high urgency of defogging and the routine proceeds to step S70 where, in accordance with the need for drying, the DRY EVA cycle (step S71), DRY ALL cycle (step S72), and HOT cycle (step S73) are selected.

When it is judged at step S74 that the vent mode is neither DEF nor manual F/D (case of NO judgment), it is judged that there is low urgency for defogging and, at step S73, the HOT cycle is selected. Due to this, the highest heating ability is exhibited.

Note that, step S70 is not necessarily required. Step S70 may also be omitted. That is, when it is judged at step S74 that the mode is DEF and manual F/D, it is also possible to select the drying heat pump cycle (DRY EVA cycle and DRY ALL cycle) unconditionally without judging the necessity of drying.

According to the present embodiment, as shown in step S74, S71, and S72, when the mode is DEF and manual F/D (defogging mode), operation by the DRY EVA cycle and DRY ALL cycle (drying heat pump cycle) is permitted, so at the time of the DEF and manual F/D (defogging mode), both a heating ability and drying ability can be exhibited. For this reason, the feeling of warmth of the passengers can be secured, the defogging ability can be secured, and in turn the practicality can be improved.

### Third Embodiment

In the above first embodiment, when the mode is the DEF and manual F/D and the cooler cycle is selected, the heat source required for heating is secured by the engine cooling water, but in the present third embodiment, as shown in FIG. 11, when the mode is the DEF and manual F/D and the cooler cycle is selected, the heat source required for heating is secured by the PTC heaters 37.

The flowchart of FIG. 11 changes the steps S33 and S34 of the flowchart of FIG. 9 to step S83, but otherwise is the same as the flowchart of FIG. 9.

When it is judged at step S82 (corresponding to step S32 of FIG. 9) that the window glass surface relative humidity RHW is higher than 90 (case of YES judgment), it is judged that there is the possibility of window fogging and the routine proceeds to step S83 where the number of PTC heaters 37 operated is increased to secure the heat sources required for heating.

In this embodiment, the number of PTC heaters 37 operated (number powered) is increased by 2 (number of operating PTC heaters+2). However, it is not possible to increase the number of PTC heaters 37 operated over the number installed. In this embodiment, three PTC heaters 37 are provided, so the number operated after increase becomes a maximum of 3.

Next, the routine proceeds to step S84 (corresponding to step S35 of FIG. 9) where the cooler cycle (cooling mode) is selected. Due to this, a strong drying operation is performed in the cooler cycle and the PTC heaters 37 are used for heating.

Note that, in the same way as the first embodiment, step S82 is not necessarily required. Step S82 may also be omitted. That is, when it is judged at step S81 that the mode is DEF and manual F/D, it is also possible to make the routine proceed to step S83 where the number of PTC heaters 37 operated is increased unconditionally without judging the possibility of window fogging.

According to the present embodiment, advantageous effects similar to those of the above first embodiment can be obtained.

### Fourth Embodiment

In the above third embodiment, when the mode is the DEF and manual F/D and the cooler cycle is selected, the PTC heaters 37 raise the vented air temperature to improve the defogging ability, but in the present fourth embodiment, as shown in FIG. 12, when the mode is the DEF and manual F/D and the cooler cycle is selected, the electric heating defogger 47 heats the window glass to improve the defogging ability.

The flowchart of FIG. 12 changes step S83 of the flowchart of FIG. 11 to step S93, but otherwise is the same as the flowchart of FIG. 11.

When it is judged at step S92 (corresponding to step S82 of FIG. 11) that the window glass surface relative humidity RHW is higher than 90 (case of YES judgment), it is judged that there is the possibility of window fogging and the routine proceeds to step S93 where it is decided to request operation of the electric heating defogger 47 (ON request) to heat the window glass.

Next, the routine proceeds to step S94 (corresponding to step S84 of FIG. 11) where the cooler cycle (cooling mode) is selected. Due to this, a strong drying operation is performed in the cooler cycle and the window glass is heated by the electric heating defogger 47, so the defogging ability can be improved.

Further, by selecting the cooler cycle, it is possible to prevent the formation of frost at the outside heat exchanger 16, so the defogging ability will not end up dropping due to formation of frost like at the time of the drying heat pump cycle.

From the above, it is possible to improve the defogging ability of the window glass and possible to prevent formation of frost at the outside heat exchanger 16, so it is possible to improve the practicality of the vehicular air-conditioning system 1.

Note that, in the same way as the third embodiment, step S92 is not necessarily required. Step S92 may also be omitted. That is, when it is judged at step S91 that the mode is DEF and manual F/D, it is also possible to make the routine proceed to step S93 where it is decided to request operation to the electric heating defogger 47 unconditionally without judging the possibility of window fogging.

### Fifth Embodiment

In the above first embodiment, when the mode is the DEF and manual F/D and the cooler cycle is selected, the heater core 36 is used for heating while in the above third embodiment, when the mode is the DEF and manual F/D and the cooler cycle is selected, the PTC heaters 37 are used for heating; but in the present fifth embodiment, as shown in FIG. 13, when the mode is the DEF and manual F/D and the cooler cycle is selected, the seat heating devices 48 are used for heating.

The flowchart of FIG. 13 changes step S83 of the flowchart of FIG. 11 to step S103, but otherwise is the same as the flowchart of FIG. 11.

When it is judged at step S102 (corresponding to step S82 of FIG. 11) that the window glass surface relative humidity RHW is higher than 90 (in case of YES judgment), it is judged that there is the possibility of window fogging and the routine proceeds to step S103 where it is decided to request operation of the seat heating devices 48 to secure a feeling of warmth of the passengers (ON request).

Next, the routine proceeds to step S104 (corresponding to step S84 of FIG. 11) where the cooler cycle (cooling mode) is selected.

Note that, in the same way as the above third and fourth embodiments, step S102 is not necessarily required. Step S102 may also be omitted. That is, when it is judged at step S101 that the mode is DEF and manual F/D, it is also possible to make the routine proceed to step S103 where an operation request to the seat heating devices 48 is decided on unconditionally without judging the possibility of window fogging.

According to this embodiment, at the time of the DEF and manual F/D, a strong drying operation is performed in the cooler cycle and the seat heating devices 48 are used so that the passengers are effectively warmed, so the defogging ability of the window glass can be improved and the feeling of warmth of the passengers can be secured.

Further, by selecting the cooler cycle, it is possible to prevent formation of frost at the outside heat exchanger 16, so the defogging ability will not end up falling due to formation of frost such as at the time of a drying heat pump cycle.

Due to the above, the practicality of the vehicular air-conditioning system 1 can be improved.

### Other Embodiments

Note that, the first to fifth embodiments only explain specific examples of the control processing of a vehicular air-conditioning system in the present invention. The invention is not limited to this. Various modifications are possible.

For example, the criteria for judgment of the possibility of window fogging in the first to fifth embodiments and the criteria for judgment of the degree of necessity for drying may be suitably changed.

For example, it is possible to suitably change the predetermined threshold value of the outside air temperature at steps S61 and 66 of the above second embodiment.

Further, in the above first to fifth embodiments, the defogging ability is improved when the vent mode is DEF and manual F/D, that is, when a passenger performs an operation to set the defogging mode, but it is also possible to improve the defogging ability when automatic control of the air-conditioning control device 50 is used to set the defogging mode.

Further, the above embodiments can also be combined in the workable range.

Further, in the above embodiments, the example of application of the vehicular air-conditioning system of the present invention to a hybrid vehicle was explained, but the coverage of the present invention is not limited to a hybrid vehicle. For example, the present invention can also be applied to vehicles designed for reducing fuel consumption by stopping the engine and various other vehicles.

### REFERENCE SIGNS LIST

10 vapor compression type refrigeration cycle
11 compressor
36 heater core (heating means)
37 PTC heater (heating means)
47 electric heating defogger (window glass heating means)
48 seat heating device
50 air-conditioning control device (control means)
60c vent mode switch
EG engine (internal combustion engine)

1. A vehicular air-conditioning system provided with
a vapor compression type refrigeration cycle having a compressor compressing and discharging a refrigerant and an outside heat exchanger exchanging heat between air outside a cabin and a refrigerant and able to switch between a cooler cycle cooling vented air to be blown inside the cabin and a heat pump cycle heating the vented air,
a heating means for using cooling water of an internal combustion engine as a heat source to heat the vented air,
a vent mode switch setting a defogging mode for blowing vented air toward vehicle window glass by operation by a passenger, and
a control means for controlling switching between the cooler cycle and heat pump cycle,
the control means selecting the cooler cycle and outputting a signal requesting operation to the internal combustion engine even when the vent mode switch is used to set the defogging mode.

2. A vehicular air-conditioning system as set forth in claim 1, wherein the control means selects the heat pump cycle instead of the cooler cycle, even when the vent mode switch is used to set the defogging mode, when the temperature of the cooling water is lower than a predetermined temperature.

3. A vehicular air-conditioning system as set forth in claim 1, wherein the control means outputs a signal requesting operation to the internal combustion engine when the vent mode switch is used to set the defogging mode and it is judged that the possibility of window fogging is high.

4. A vehicular air-conditioning system as set forth in claim 1, wherein the control means selects the cooler cycle when the vent mode switch is used to set the defogging mode and it is judged that the possibility of window fogging is high.

5. A vehicular air-conditioning system provided with
a vapor compression type refrigeration cycle having a compressor designed to be able to switch between a non-drying heat pump cycle heating the vented air blown into a cabin without drying it and a drying heat pump cycle drying and heating the vented air,
a vent mode switch setting a defogging mode for blowing vented air toward vehicle window glass by operation by a passenger, and
a control means for controlling switching between the non-drying heat pump cycle and the drying heat pump cycle,
the control means permitting operation by the drying heat pump cycle when the vent mode switch is used to set the defogging mode.

6. A vehicular air-conditioning system provided with
a vapor compression type refrigeration cycle having a compressor compressing and discharging a refrigerant and an outside heat exchanger exchanging heat between air outside a cabin and a refrigerant and able to switch between a cooler cycle cooling vented air to be blown inside the cabin and a heat pump cycle heating the vented air,
heating means for using a source other than the refrigerant as heat to heat the vented air,
a vent mode switch setting a defogging mode for blowing vented air toward vehicle window glass by operation by a passenger, and
a control means for controlling switching between the cooler cycle and heat pump cycle,
the control means selecting the cooler cycle and increasing the heating ability of the heating means when the vent mode switch is used to set the defogging mode.

7. A vehicular air-conditioning system provided with
a vapor compression type refrigeration cycle having a compressor compressing and discharging a refrigerant and an outside heat exchanger exchanging heat between air outside a cabin and a refrigerant and able to switch between a cooler cycle cooling vented air to be blown inside the cabin and a heat pump cycle heating the vented air,
a window glass heating means for heating the vehicle window glass,
a vent mode switch setting a defogging mode for blowing vented air toward the vehicle window glass by operation by a passenger, and
a control means for controlling switching between the cooler cycle and heat pump cycle,
the control means selecting the cooler cycle and operating the window glass heating means when the vent mode switch is used to set the defogging mode.

8. A vehicular air-conditioning system provided with
a vapor compression type refrigeration cycle having a compressor compressing and discharging a refrigerant and an outside heat exchanger exchanging heat between air outside a cabin and a refrigerant and able to switch between a cooler cycle cooling vented air to be blown inside the cabin and a heat pump cycle heating the vented air,
a seat heating device arranged at a seat,
a vent mode switch setting a defogging mode for blowing vented air toward the vehicle window glass by operation by a passenger, and
a control means for controlling switching between the cooler cycle and heat pump cycle,
the control means selecting the cooler cycle and operating the seat heating device when the vent mode switch is used to set the defogging mode.
